(19) United States
(12) Patent Application Publication
(10) Pub. No.: US 2015/0285834 A1
(43) Pub. Date: Oct. 8, 2015

(54) SENSOR, COMPUTING DEVICE, AND MOTION ANALYZING APPARATUS

(71) Applicant: SEIKO EPSON CORPORATION, Tokyo (JP)

(72) Inventors: Kazuhiro SHIBUYA, Shiojiri-shi (JP); Kyoko NISHIJIMA, Shiojiri-shi (JP)

(21) Appl. No.: 14/669,746

(22) Filed: Mar. 26, 2015

(30) Foreign Application Priority Data
Apr. 8, 2014 (JP) 2014-079188
Sep. 26, 2014 (JP) 2014-197266

(51) Int. Cl. G01P 13/00; A63B 24/00; A63B 69/36

(52) U.S. Cl. CPC G01P 13/00; A63B 69/36; A63B 24/0003; A63B 2220/803; A63B 2208/0204

(57) ABSTRACT

A sensor unit includes a measuring section and a sampling-rate switching section configured to switch a sampling rate at which the measuring section performs measurement. The measuring section performs the measurement at a first sampling rate in a standstill period of a user and, in a motion period of the user, switches, with the sampling-rate switching section, the sampling rate to a second sampling rate and performs the measurement. The first sampling rate is lower than the second sampling rate.

### BACKGROUND

1. Technical Field

The present invention relates to a sensor, a computing device, and a motion analyzing apparatus.

2. Related Art

In a motion analysis of swing, a posture of an exercise instrument during the swing changes at every moment. The swing is visually reproduced by, for example, displaying a locus on the basis of an output of an inertial sensor mounted on the exercise instrument or a hand. As a specific example of such a motion analyzing apparatus, a swing evaluation supporting apparatus that analyzes swing of a golf club is disclosed (see, for example, JP-A-2008-73210 (Patent Literature 1)).

The swing evaluation supporting apparatus disclosed in Patent Literature 1 includes a behavior detecting device (a measuring section) mounted on the golf club and a behavior analyzing device (an analyzing section) that analyzes and evaluates behavior data acquired by the behavior detecting device. In the swing evaluation supporting apparatus, a three-axis acceleration sensor and a three-axis gyro sensor are mounted on the golf club as inertial sensors in the behavior detecting device mounted on the golf club. Behavior data acquired by the three-axis acceleration sensor and the three-axis gyro sensor is stored in a storage device. The stored behavior data is transmitted to the behavior analyzing device. The behavior analyzing device performs processing for evaluating and analyzing a behavior (an action) of swing of the golf club on the basis of the received behavior data. An evaluation and analysis result is output to a display device and displayed as an image. According to the method of Patent Literature 1, compared with a method of subjecting a video of swing photographed by a camera to image processing and analyzing the swing, it is possible to greatly reduce computational complexity. Further, according to the method of Patent Literature 1, since a large device such as a camera is unnecessary, a place where a user swings the golf club is not limited.

When a swing motion is measured using an output of a sensor, in some case, a user is asked to stand still for a few seconds before starting swing and a computing device performs, using a sensor output in a standstill period of the user, calibration for obtaining a zero-point bias value of the sensor output. To accurately measure the swing motion, a sampling rate of the sensor is desirably higher. However, as the sampling rate of the sensor is higher, a data transmission amount from the sensor to the computing device increases. As a result, time until the computing device detects the standstill period of the user in the calibration increases. The user has to continue to stand still until the computing device detects the standstill period. Therefore, convenience for the user is poor. Such a problem occurs not only in the swing motion of the golf but also in any motion.

For example, in order to accurately perform detection (measurement) of an action with high motion speed such as golf swing, detection (measurement) at a relatively high sampling rate is requested. However, when the motion is detected (measured) at the relatively high sampling rate, a data amount is enormous and a communication amount is also large. Therefore, if the once-stored behavior data is directly transmitted to the behavior analyzing device and analyzed and evaluated as in Patent Literature 1, a communication time and a data processing time increase. It takes long to display a result on the display device. That is, a so-called time lag occurs. As a result, the user is kept waited until the start of the next motion after the analyzed motion. Therefore, convenience of use for the user is poor.

### SUMMARY

An advantage of some aspects of the invention is to provide a sensor, a computing device, a motion measuring method, a motion measuring system, a computer program, a motion analyzing apparatus, a motion analyzing method, a motion analyzing program, and motion analysis display that can reduce time required for detection of a standstill period of a measurement object.

The invention can be implemented as the following aspects or application examples.

### Application Example 1

A sensor according to this application example includes: a measuring section; and a sampling-rate switching section configured to switch a sampling rate at which the measuring section performs measurement, in which the measuring section performs the measurement at a first sampling rate in a standstill period of a measurement object and, in a motion period of the measurement object, switches the sampling rate to a second sampling rate with the sampling-rate switching section and performs the measurement, and the first sampling rate is lower than the second sampling rate.

The sensor according to this application example may be, for example, an inertial sensor. The inertial sensor may be, for example, an acceleration sensor, may be an angular velocity sensor, or may be a sensor unit including the acceleration sensor and the angular velocity sensor.

The measurement object may be, for example, an exercise instrument (e.g., a golf club, a tennis racket, a bat of baseball, or a stick of hockey) on which the sensor according to this application example is mounted, may be a user who uses the exercise instrument, or may be a user who wears the sensor according to this application example. The motion period of the measurement object may be, for example, a period in which the user swings the exercise instrument.

Focusing on the fact that fluctuation in measurement data is small when the measurement object hardly moves, the sensor according to this application example can reduce an amount of measurement data by measuring, in the standstill period of the measurement object, the measurement object at the first sampling rate lower than the second sampling rate in the motion period of the measurement object. Therefore, it is possible to reduce time required for detection of the standstill period of the measurement object by using measurement data measured by the sensor according to this application example in the standstill period of the measurement object.

### Application Example 2

In the sensor according to the application example, the sampling-rate switching section may switch the first sampling rate to the second sampling rate on the basis of a first switching signal from the outside.

### Application Example 3

A computing device according to this application example includes: a standstill-period detecting section configured to detect, on the basis of first measurement data measured by a sensor at a first sampling rate, a standstill period in which a measurement object stands still; and a sensor control section configured to transmit, when the standstill-period detecting section detects the standstill period, to the sensor, a first switching signal for instructing switching to a second sampling rate, in which the first sampling rate is lower than the second sampling rate.

With the computing device according to this application example, it is possible to reduce time required for detection of the standstill period of the measurement object on the basis of the first measurement data, a data amount of which is reduced by the sensor measuring the measurement object in the standstill period of the measurement object at the first sampling rate lower than the second sampling rate in a motion period of the measurement object.

### Application Example 4

In the computing device according to the application example, the standstill-period detecting section may detect the standstill period when the first measurement data is within a predetermined range in a predetermined time.

### Application Example 5

The computing device according to the application example may include a zero-point-bias calculating section configured to calculate a zero-point bias value of the first measurement data of the sensor when the standstill-period detecting section detects the standstill period.

### Application Example 6

In the computing device according to the application example, the zero-point-bias calculating section may calculate an average of the first measurement data in the standstill period and set the average as the zero-point bias value.

### Application Example 7

The computing device according to the application example may include a motion analyzing section configured to analyze a motion of the measurement object using second measurement data measured by the sensor at the second sampling rate.

In the computing device according to this application example, in order to acquire a sufficient amount of measurement data in the motion period of the measurement object, in the motion period of the measurement object, the sensor performs the measurement at the second sampling rate higher than the first sampling rate in the standstill period of the measurement object. Therefore, with the computing device according to the application example, it is possible to acquire a sufficient amount of the second measurement data in the motion period of the measurement object. Therefore, the computing device can accurately analyze a motion of the measurement object on the basis of the second measurement data.

### Application Example 8

The computing device according to the application example may include a motion-end detecting section configured to detect an end of a motion of the measurement object, in which when the motion-end detecting section detects the end of the motion of the measurement object, the sensor control section may transmit, to the sensor, a second switching signal for instructing switching to the first sampling rate.

With the computing device according to this application example, after the end of the motion of the measurement object, it is possible to reduce an amount of measurement data of the sensor.

### Application Example 9

In the computing device according to the application example, the first sampling rate may be equal to or lower than an output rate at which the sensor outputs the first measurement data.

With the computing device according to this application example, the sensor can output, without a delay, the first measurement data measured in the standstill period of the measurement object. Therefore, the computing device can detect the standstill period of the measurement object without a delay.

### Application Example 10

A motion measuring method according to this application example includes: a first measurement-data output step in which a sensor performs measurement at a first sampling rate in a standstill period of a measurement object and outputs measured first measurement data; and a second measurement-data output step in which, in a motion period of the measurement object, the sensor performs the measurement at a second sampling rate and outputs measured second measurement data, in which the first sampling rate is lower than the second sampling rate.

In the motion measuring method according to this application example, focusing on the fact that an amount of measurement data may be reduced because fluctuation in the measurement data is small in the standstill period in which the measurement object hardly moves, in the standstill period of the measurement object, the sensor performs the measurement at the first sampling rate lower than the second sampling rate in the motion period of the measurement object. Therefore, with the motion measuring method according to this application example, by reducing an amount of the first measurement data in the standstill period of the measurement object, it is possible to reduce time required for detection of the standstill period of the measurement object based on the first measurement data.

### Application Example 11

A motion measuring method according to this application example includes: a first measurement-data output step in which a sensor performs measurement at a first sampling rate and outputs measured first measurement data; a standstill-period detecting step in which a computing device detects, on the basis of the first measurement data, a standstill period in which a measurement object stands still; a first-switching-signal transmitting step in which, when detecting the standstill period, the computing device transmits, to the sensor, a first switching signal for instructing switching to a second sampling rate; a first-sampling-rate switching step in which the sensor switching a sampling rate to the second sampling rate on the basis of the first switching signal; and a second-measurement-data output step in which the sensor performs the measurement at the second sampling rate and outputs measured second measurement data, in which the first sampling rate is lower than the second sampling rate.

In the motion measuring method according to this application example, focusing on the fact that an amount of measurement data may be reduced because fluctuation in the measurement data is small in the standstill period in which the measurement object hardly moves, in the standstill period of the measurement object, the sensor performs the measurement at the first sampling rate lower than the second sampling rate in the motion period of the measurement object. Therefore, with the motion measuring method according to this application example, by reducing an amount of the first measurement data in the standstill period of the measurement object, it is possible to reduce time required for detection of the standstill period of the measurement object based on the first measurement data.

The motion measuring method according to this application example may include a zero-point-bias calculating step in which, when detecting the standstill period, the computing device calculates a zero-point bias value of the first measurement data of the sensor. In the zero-point-bias calculating step, the computing device may calculate an average of the first measurement data in the standstill period and set the average as the zero-point bias value.

The motion measuring method according to this application example may include a motion analyzing step in which the computing device analyzes a motion of the measurement object using the second measurement data measured by the sensor at the second sampling rate.

The motion measuring method according to this application example may include: a motion-end detecting step in which the computing device detects an end of a motion of the measurement object; and a second-switching-signal transmitting step in which, when detecting the end of the motion of the measurement object, the computing device transmits, to the sensor, a second switching signal for instructing switching to the first sampling rate.

Further, the motion measuring method according to this application example may include a second-sampling-rate switching step in which the sensor switches the sampling rate to the first sampling rate on the basis of the second switching signal.

### Application Example 12

A motion measuring system according to this application example includes a sensor and a computing device, in which the sensor includes: a measuring section; and a sampling-rate switching section configured to switch a sampling rate at which the measuring section performs measurement. The computing device includes: a standstill-period detecting section configured to detect, on the basis of first measurement data measured by the sensor at a first sampling rate, a standstill period in which a measurement object stands still; and a sensor control section configured to transmit, when the standstill-period detecting section detects the standstill period, to the sensor, a first switching signal for instructing switching to a second sampling rate, and the first sampling rate is lower than the second sampling rate.

With the motion measuring system according to this application example, the sensor can reduce an amount of the first measurement data by measuring, in the standstill period of the measurement object, the measurement object at the first sampling rate lower than the second sampling rate in the motion period of the measurement object. Therefore, the computing device can reduce time required for detection of the standstill period of the measurement object based on the first measurement data.

### Application Example 13

A computer program according to this application example causes a computer to execute: a standstill-period detecting step for detecting, on the basis of first measurement data measured by a sensor at a first sampling rate, a standstill period in which the measurement object stands still; and a first-switching-signal transmitting step for transmitting, when the standstill period is detected in the stand-still-period detecting step, to the sensor, a first switching signal for instructing switching to a second sampling rate higher than the first sampling rate.

With the computer program according to this application example, it is possible to reduce time required for detection of the standstill period of the measurement object on the basis of the first measurement data, a data amount of which is reduced by the sensor measuring the measurement object in the standstill period of the measurement object at the first sampling rate lower than the second sampling rate in a motion period of the measurement object.

### Application Example 14

A motion analyzing apparatus according to this application example includes: a measuring section configured to measure a motion as first data at a first sampling rate; a data processing section configured to process the first data into a second sampling rate lower than the first sampling rate to obtain second data; a detecting section configured to detect an event of the motion from the second data; a range designating section configured to designate a time range in the motion on the basis of the detected event and receive the first data in the time range as third data; and an analyzing section configured to analyze the motion using the second data and the third data.

According to this application example, the first data measured at the relatively high first sampling rate is stored in a memory or the like. The second data obtained by processing the first data into the second sampling rate lower than the first sampling rate is acquired. The event of the motion is detected from the second data. The time range is designated on the basis of the detected event. The third data, the time range of which is designated, is acquired out of the stored first data. In this way, the analysis of the motion is performed using, in a range in which a detailed analysis evaluation is necessary, the third data measured at the relatively high first sampling rate and using, in other ranges, the second data processed to the relatively low second sampling rate. Therefore, it is possible to reduce a data amount and reduce a data processing time including a communication time of data. As a result, it is possible to reduce or prevent a time lag from a motion end to presentation of an analysis evaluation result. It is possible to reduce an analysis evaluation time of the motion. Consequently, the user is enabled to be less frequently kept waited or not to be kept waited at all until the start of the next motion after the analyzed motion. Therefore, it is possible to improve convenience of use for the user.

### Application Example 15

In the motion analyzing apparatus according to the application example, it is preferable that the detecting section detects, as the event, a standstill state of the motion on the basis of the second data.

According to this application example, the event of the motion is detected on the second data of the low second sampling rate, which is a sampling rate at which transmission on a real-time basis is possible. Therefore, it is possible to detect the standstill on a real-time basis. It is possible to improve convenience of use.

### Application Example 16

In the motion analyzing apparatus according to the application example, it is preferable that the data processing section performs processing for calculating an average of the first data within a sampling interval of the second sampling rate.

According to this application example, it is possible to perform, with a simple method, data thinning processing for processing the first data measured at the relatively high first sampling rate into the second sampling rate lower than the first sampling rate.

### Application Example 17

In the motion analyzing apparatus according to the application example, it is preferable that the time range is set to a range before and after a point in time of a maximum of an inertial amount in the motion.

According to this application example, even if a time range is not manually input, for example, it is possible to automatically designate a range from a measurement value of a sensor and perform an analysis evaluation. Therefore, it is possible to improve convenience of use.

### Application Example 18

In the motion analyzing apparatus according to the application example, it is preferable that a plurality of the time ranges are set.

According to this application example, it is possible to optionally set a plurality of analysis evaluation ranges (analysis evaluation places) that a user (a subject) desires to know in detail. Therefore, it is possible to obtain a more detailed analysis evaluation result. It is possible to improve convenience of use.

### Application Example 19

In the motion analyzing apparatus according to the application example, it is preferable that the measuring section and the data processing section are provided in a first calculating section, and the detecting section, the range designating section, and the analyzing section are provided in a second calculating section.

According to this application example, for example, it is possible to perform, on the first calculating section side, processing on the second calculating section side. It is possible to reduce a calculation load on the second calculating section.

### Application Example 20

In the motion analyzing apparatus according to the application example, it is preferable that the motion is swing performed using an exercise instrument.

According to this application example, it is possible to reduce or prevent a time lag from an end of swing performed using, for example, a golf club as an exercise instrument to presentation of an analysis evaluation result. It is possible to reduce an analysis evaluation time of the swing. Consequently, after performing an analysis of the swing, the user is enabled to be less frequently kept waited or not to be kept waited at all until the start of the next swing. Therefore, it is possible to improve convenience of use for the user.

### Application Example 21

A motion analyzing method according to this application example includes: measuring a motion as first data at a first sampling rate; processing the first data into a second sampling rate lower than the first sampling rate to obtain second data; detecting an event of the motion from the second data; designating a time range in the motion on the basis of the detected event and acquiring the first data in the time range as third data; and analyzing the motion using the second data and the third data.

According to this application example, the first data measured at the relatively high first sampling rate is stored in a memory or the like. The second data obtained by processing the first data into the second sampling rate lower than the first sampling rate is acquired. The event of the motion is detected from the second data. The time range is designated on the basis of the detected event. The third data, the time range of which is designated, is acquired out of the stored first data. In this way, the analysis of the motion is performed using, in a range in which a detailed analysis evaluation is necessary, the third data measured at the relatively high first sampling rate and using, in other ranges, the second data processed to the relatively low second sampling rate. Therefore, it is possible to reduce a data amount and reduce a data processing time. As a result, it is possible to reduce a time lag from a motion end to presentation of an analysis evaluation result. It is possible to reduce an analysis evaluation time of the motion.

### Application Example 22

It is preferable that the motion analyzing method according to the application example includes determining, using the second data, whether the motion stands still, and information is given when it is determined that the motion stands still.

According to this application example, it is possible to use, as a sign for staring the motion, the information is given when it is determined that the motion stands still, and therefore it is possible to improve accuracy of an analysis evaluation result and convenience of use.

### Application Example 23

A motion analyzing program according to this application example causes a computer to execute: a step of measuring, from an output of an inertial sensor, a motion as first data at a first sampling rate; a step of processing the first data into a second sampling rate lower than the first sampling rate to obtain second data; a step of detecting an event of the motion from the second data; a step of designating a time range in the motion on the basis of the detected event, requesting the first data in the time range, and acquiring the first data as third data; and a step of analyzing the motion using the second data and the third data.

According to this application example, the computer executes the program including the steps. Consequently, the first data measured at the relatively high first sampling rate is stored in a memory or the like. The second data obtained by processing the first data into the second sampling rate lower than the first sampling rate is acquired. The event of the motion is detected from the second data. The time range is designated on the basis of the detected event. The third data, the time range of which is designated, is acquired out of the stored first data. In this way, the analysis of the motion is performed using, in a range in which a detailed analysis evaluation is necessary, the third data measured at the relatively high first sampling rate and using, in other ranges, the second data processed to the relatively low second sampling rate. Therefore, it is possible to reduce a data amount and reduce a data processing time. As a result, it is possible to reduce a time lag from a motion end to presentation of an analysis evaluation result. It is possible to reduce an analysis evaluation time of the motion.

### Application Example 24

A motion analysis display method according to this application example includes displaying a result of analyzing a motion according to first data obtained by measuring the motion at a first sampling rate, second data obtained by processing the first data into a second sampling rate lower than the first sampling rate, and third data acquired by designating a time range in the motion out of the first data on the basis of a detection result of the motion obtained from the second data, the second data and the third data being displayed as a series of data.

According to this application example, the result obtaining by analyzing the motion is displayed by displaying, as a series of data, the second data obtained by processing the first data into the second sampling rate lower than the first sampling rate and the third data acquired by designating the time range out of the first data measured at the relatively high sampling rate. Consequently, it is possible to easily visually recognize the data at the different sampling rates as one rendered image.

### BRIEF DESCRIPTION OF THE DRAWINGS

The invention will be described with reference to the accompanying drawings, wherein like numbers reference like elements.

FIG. 1 is an explanatory diagram of an overview of a motion measuring system in a first embodiment.

FIG. 2 is a diagram showing an example of a mounting position and a mounting direction of a sensor unit.

FIG. 3 is a diagram showing a procedure of an operation performed by a user in the first embodiment.

FIG. 4 is a diagram showing an example of a screen displayed on a display section of a computing device.

FIG. 5 is a diagram showing a configuration example of a motion measuring system in the first embodiment.

FIG. 6 is a diagram of an example of a time chart of actions of the user, processing of the sensor unit, and processing of the computing device in the first embodiment.

FIG. 7 is a flowchart for explaining an example of a procedure of motion measurement processing by the computing device in the first embodiment.

FIG. 8 is a flowchart for explaining an example of a procedure of measurement processing by a sensor unit in the first embodiment.

FIG. 9 is a diagram showing a configuration example of a motion measuring system in a second embodiment.

FIG. 10 is a diagram showing an example of a time chart of actions of a user, processing of a sensor unit, and processing of a computing device in the second embodiment.

FIG. 11 is a flowchart for explaining an example of a procedure of motion measurement processing by the computing device in the second embodiment.

FIG. 12 is a flowchart showing an example of a procedure of measurement processing by the sensor unit in the second embodiment.

FIG. 13 is a diagram showing a configuration example of a motion measuring system in a third embodiment.

FIG. 14 is a diagram showing an example of a time chart of actions of a user, processing of a sensor unit, and processing of a computing device in the third embodiment.

FIG. 15 is a flowchart showing an example of a procedure of motion measurement processing by the computing device in the third embodiment.

FIG. 16 is a flowchart for explaining an example of a procedure of measurement processing by the sensor unit in the third embodiment.

FIG. 17 is a conceptual diagram schematically showing the configuration of a golf swing analyzing apparatus (a motion analyzing apparatus) in a fourth embodiment of the invention.

FIG. 18 is a block diagram schematically showing the configuration of the golf swing analyzing apparatus in the fourth embodiment.

FIG. 19 is a flowchart showing a golf swing analyzing method (a motion analyzing method) in the fourth embodiment.

FIG. 20 is a conceptual diagram showing the golf swing analyzing method (the motion analyzing method) in the fourth embodiment.

FIGS. 21A and 21B are conceptual diagrams showing a display example of a golf swing analysis in an analysis display method in the fourth embodiment.

### DESCRIPTION OF EXEMPLARY EMBODIMENTS

Preferred embodiments of the invention are explained in detail below with reference to the drawings. Note that the embodiments explained below do not unduly limit contents of the invention described in the appended claims. Not all of components explained below are essential constituent elements of the invention.

In the following explanation, a motion measuring system (a swing measuring system) that performs an analysis of golf swing is explained as an example.

### 1. Motion Measuring System

### 1-1. First Embodiment

### 1-1-1. Overview of the Motion Measuring System

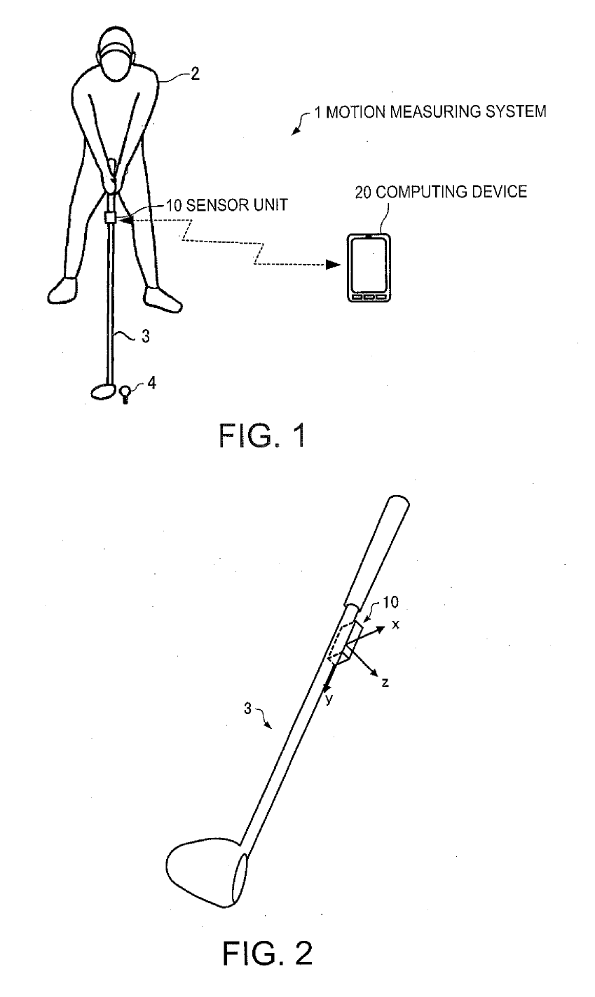

FIG. 1 is a diagram for explaining an overview of a motion measuring system in this embodiment. A motion measuring system 1 in this embodiment includes a sensor unit 10 (an example of a sensor) and a computing device 20.

The sensor unit 10 is capable of measuring accelerations generated in axial directions of three axes and angular velocities generated around the three axes. The sensor unit 10 is mounted on a golf club 3.

In this embodiment, as shown in FIG. 2, the sensor unit 10 is attached to a part of a shaft of the golf club 3 with one axis among three detection axes (an x axis, a y axis, and a z axis), for example, the y axis set in the major axis direction of the shaft. The sensor unit 10 is desirably attached to a position close to a grip to which a shock during ball hitting is less easily transmitted and to which a centrifugal force is not applied during swing. The shaft is a portion of a handle excluding the head of the golf club 3 and includes the grip. However, the sensor unit 10 may be attached to a part (e.g., a hand or a glove) of a user 2 (an example of the measurement object) or may be attached to an accessory such as a wristwatch.

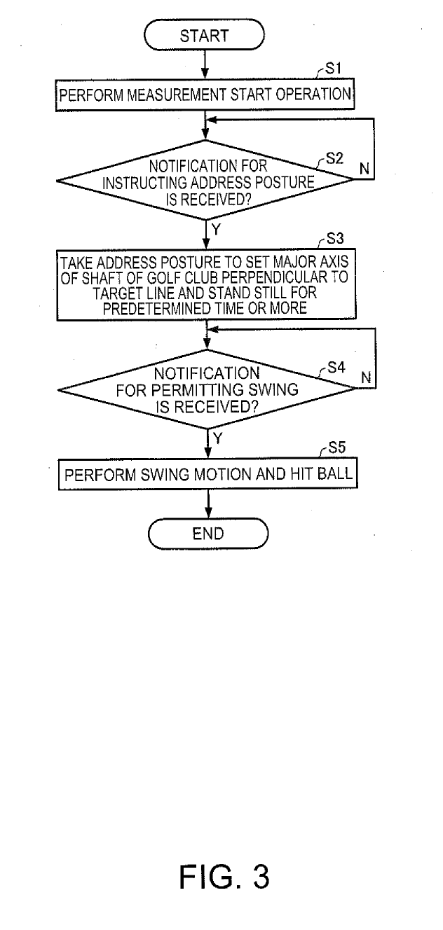

The user 2 performs a swing motion for hitting a golf ball 4 according to a predetermined procedure. FIG. 3 is a diagram showing a procedure of an action performed by the user 2. As shown in FIG. 3, first, the user 2 performs measurement start operation (operation for causing the sensor unit 10 to start measurement) via the computing device 20 (S1). Subsequently, after receiving notification (e.g., notification by voice) for instructing the user 2 to take an address posture from the computing device 20 (Y in S2), the user 2 takes the address posture to set the major axis of the shaft of the golf club 3 perpendicular to a target line (a target direction of ball hitting), and stands still (S3). Subsequently, after receiving notification (e.g., notification by voice) for permitting swing from the computing device 20 (Y in S4), the user 2 performs a swing motion and hits the golf ball 4 (S5).

When the user 2 performs the measurement start operation in S1 in FIG. 3, the sensor unit 10 measures three-axis accelerations and three-axis angular velocities and sequentially transmits measured data to the computing device 20. Communication between the sensor unit 10 and the computing device 20 may be radio communication or may be wired communication.

The computing device 20 analyzes, using the data measured by the sensor unit 10, the swing motion of the user 2 hitting the ball using the golf club 3. For example, the computing device 20 may generate locus information of the head and the grip end of the golf club 3 in the swing using the measurement data measured by the sensor unit 10 and display the locus information on a display section (a display). The computing device 20 may be, for example, a portable device such as a smart phone or a personal computer (PC).

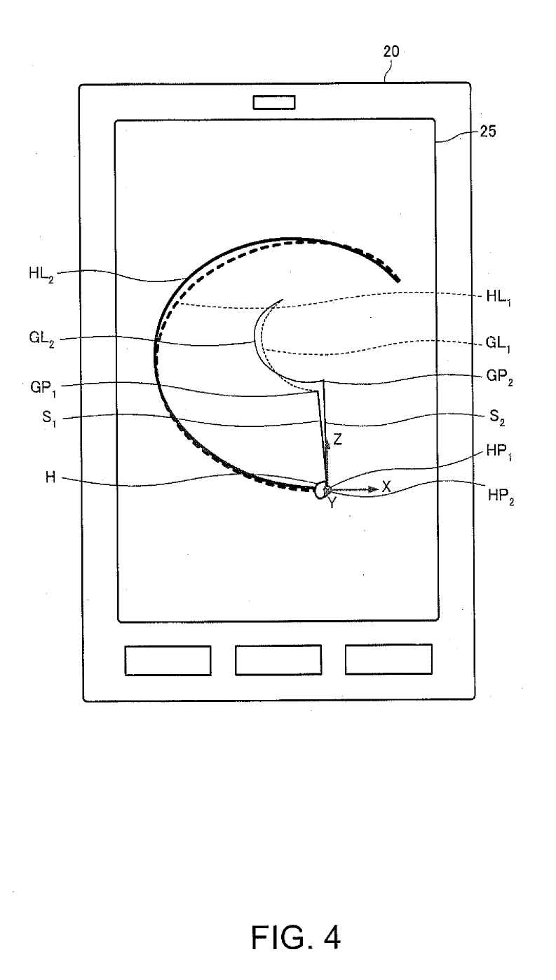

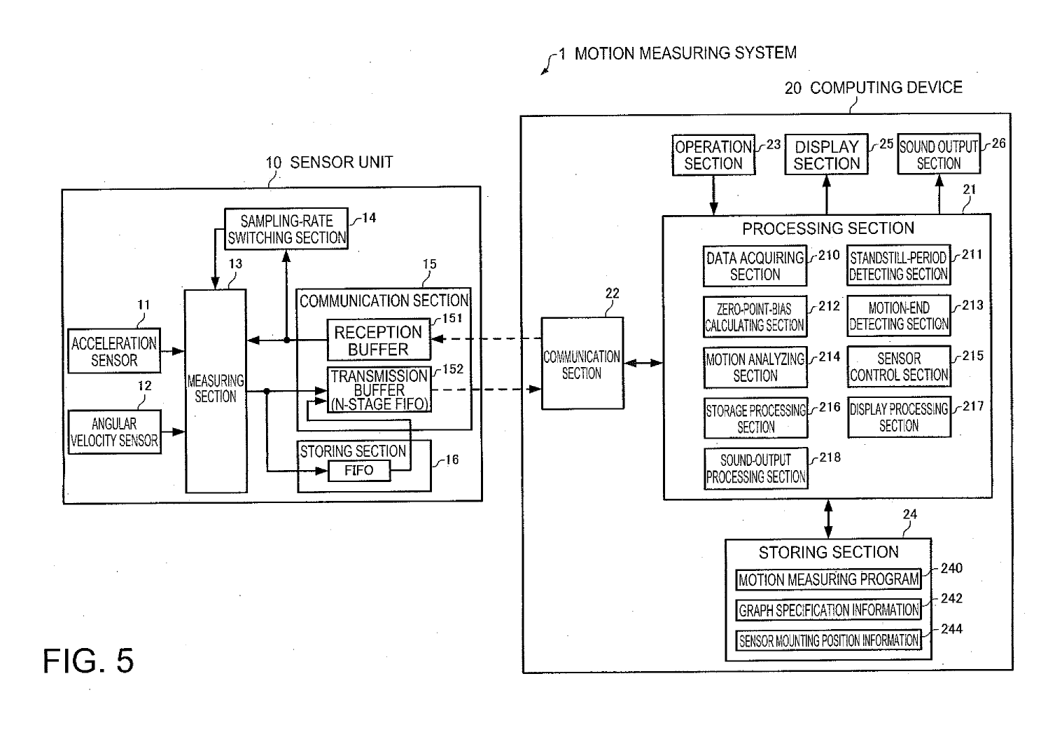

FIG. 4 is a diagram showing an example of a screen displayed on a display section 25 (see FIG. 5) of the computing device 20. In this embodiment, an XYZ coordinate system (a global coordinate system) is defined in which a target line indicating a target direction of ball hitting is an X axis, an axis on a horizontal plane perpendicular to the X axis is a Y axis, and a vertical upward direction (the opposite direction of the direction of the gravitational acceleration) is a Z axis. The screen shown in FIG. 4 includes information concerning the X axis, the Y axis, and the Z axis. On the screen in FIG. 4, S1, HP1, and GP1 respectively indicate the shaft, the position of the head, and the position of the grip at the start of the swing. S2, HP2, and GP2 respectively indicate the shaft, the position of the head, and the position of the grip at the time of impact. The position HP1 of the head at the start of the swing corresponds to the origin (0, 0, 0) of the XYZ coordinate system. A broken line HL1 and a solid line HL2 are respectively a locus during a backswing and a locus during a downswing of the head. A broken line GL1 and a solid line GL2 are respectively a locus during the backswing and a locus during the downswing of the grip. A connection point of the broken line HL1 and the solid line HL2 and a connection point of the broken line GL1 and the solid line GL2 are respectively equivalent to the position of the head and the position of the grip at the time of the top of the swing (at the time when the direction of the swing is switched).

In this embodiment, according to the measurement start operation of the user 2 in S1 in FIG. 3, the sensor unit 10 starts measurement at a first sampling rate (e.g., 250 Hz). The sensor unit 10 performs measurement at the first sampling rate in a standstill period in which the user stands still in S3 in FIG. 3 (an example of the standstill period of the measurement object), outputs measured measurement data (an example of the first measurement data), and transmits the measurement data to the computing device 20 (an example of the first-measurement-data output step).

The computing device 20 receives the measurement data at the first sampling rate and detects a predetermined standstill period (e.g., a standstill period of one second) of the user 2 on the basis of the measurement data (an example of the standstill-period detecting step). When detecting the standstill period of the user 2, the computing device 20 transmits, to the sensor unit 10, a high-rate setting command (an example of the first switching signal) for instructing switching to a second sampling rate (e.g., 1 kHz) (an example of the first-switching-signal transmitting step).

The sensor unit 10 receives the high-rate setting command and switches a sampling rate to the second sampling rate on the basis of the command (an example of the first-sampling-rate switching step). In a period of the swing motion of the user in S5 in FIG. 3 (an example of the motion period of the measurement object), the sensor unit 10 performs the measurement at the second sampling rate, outputs measured measurement data (an example of the second measurement data), and transmits the measurement data to the computing device 20 (an example of the second-measurement-data output step).

The computing device 20 receives the measurement data at the second sampling rate and analyzes the swing motion of the user 2 using the measurement data (an example of the motion analyzing step).

Further, the computing device 20 receives the measurement data at the second sapling rate and detects an end of the swing motion of the user 2 (an example of the motion-end detecting step). When detecting the end of the swing motion of the user 2, the computing device 20 transmits, to the sensor unit 10, a low-rate setting command (an example of the second switching signal) for instructing switching to the first sampling rate (an example of the second-switching-signal transmitting step).

The sensor unit 10 receives the low-rate setting command and switches the sampling rate to the first sampling rate on the basis of the command (an example of the second-sampling-rate switching step).

### 1-1-2. Configuration of the Motion Measuring System

FIG. 5 is a diagram showing a configuration example of the motion measuring system 1 (configuration examples of the sensor unit 10 and the computing device 20) in the first embodiment. As shown in FIG. 5, in this embodiment, the sensor unit 10 includes an acceleration sensor 11, an angular velocity sensor 12, a measuring section 13, a sampling-rate switching section 14, a communication section 15, and a storing section 16.

The acceleration sensor 11 measures accelerations respectively generated in three axial directions crossing one another (ideally, orthogonal to one another) and outputs digital signals (acceleration data) corresponding to the magnitudes and the directions of the measured three-axis accelerations.

The angular velocity sensor 12 measures angular velocities respectively generated around three axes crossing one another (ideally, orthogonal to one another) and outputs digital signals (angular velocity data) corresponding to the magnitudes and the directions of the measured three-axis angular velocities.

When receiving a measurement start command from the communication section 15, the measuring section 13 acquires acceleration data and angular velocity data respectively from the acceleration sensor 11 and the angular velocity sensor 12, adds time information to the acceleration data and the angular velocity data to generate measurement data adjusted to a format for communication, and outputs the measurement data to the communication section 15. When receiving a measurement end command from the communication section 15, the measuring section 13 ends (stops) the acquisition of the acceleration data and the angular velocity data, the generation of the measurement data, and the output of the measurement data to the communication section 15.

Each of the acceleration sensor 11 and the angular velocity sensor 12 is ideally attached to the sensor unit 10 such that the three axes thereof coincide with the three axes (the x axis, the y axis, and the z axis) of a rectangular coordinate system (a sensor coordinate system) defined with respect to the sensor unit 10. However, actually, an error of an attachment angle occurs. Therefore, the measuring section 13 may perform processing for converting the acceleration data and the angular velocity data into data of the xyz coordinate system using correction parameters calculated in advance according to the attachment angle error.

Further, the measuring section 13 may perform temperature correction processing for the acceleration sensor 11 and the angular velocity sensor 12. Alternatively, a function of temperature correction may be incorporated in the acceleration sensor 11 and the angular velocity sensor 12.

Note that the acceleration sensor 11 and the angular velocity sensor 12 may output analog signals. In this case, the measuring section 13 only has to A/D-convert each of an output signal of the acceleration sensor 11 and an output signal of the angular velocity sensor 12 to generate measurement data.

The sampling-rate switching section 14 switches the sampling rate for the measurement by the measuring section 13 (for acquiring three-axis acceleration data and thee-axis angular velocity data). In this embodiment, when receiving the measurement start command from the communication section 15, the measuring section 13 starts measurement at the first sampling rate (e.g., 250 Hz). When receiving the high-rate setting command from the communication section 15, the sampling-rate switching section 14 switches the sampling rate of the measuring section 13 to the second sampling rate (e.g., 1 kHz). When receiving the low-rate setting command from the communication section 15 when the sampling rate of the measuring section 13 is the second sampling rate, the sampling-rate switching section 14 switches the sampling rate of the measuring section 13 to the first sampling rate.

The communication section 15 performs, for example, processing for receiving measurement data output by the measuring section 13 and transmitting the measurement data to the computing device 20 and processing for receiving various control commands (the measurement start command, the measurement end command, the high-rate setting command, the low-rate setting command, etc.) from the computing device 20 and sending the control commands to the measuring section 13 or the sampling-rate switching section 14. In this embodiment, the communication section 15 includes a reception buffer 151 and a transmission buffer 152.

The communication section 15 writes the control commands transmitted by the computing device 20 in the reception buffer 151 to receive the control commands. The transmission buffer 152 is configured as an FIFO (First-In First-Out) of N stages (N is a positive integer). When the measuring section 13 outputs measured measurement data to the outside, the transmission buffer 152 can retain up to N measurement data. When transmission to the computing device 20 is possible, the communication section 15 transmits measurement data at the top of the transmission buffer 152 (the N-stage FIFO) to the computing device 20.

When generating measurement data, if there is a space in the transmission buffer 152 (the N-stage FIFO), the measuring section 13 writes the measurement data in the last of the transmission buffer 152 (the N-stage FIFO). If there is no space in the transmission buffer 152 (the N-state FIFO), that is, if the transmission buffer 152 (the N-stage FIFO) is full (the transmission buffer 152 retains N measurement data), the measuring section 13 writes the measurement data in the last of an FIFO configured in the storing section 16.

When a space is generated in the transmission buffer 152 (the N-stage FIFO), if measurement data is written in the FIFO configured in the storing section 16, the communication section 15 extracts measurement data written in the top of the FIFO configured in the storing section 16 and writes the measurement data in the last of the transmission buffer 152 (the N-stage FIFO).

The storing section 16 is a large-capacity memory. The FIFO configured in the storing section 16 is set to a size sufficient for storing all measurement data necessary for processing of the computing device 20 taking into account, for example, time required for a series of actions (actions such as address, waggle, and swing) related to the swing motion of the user 2 and a communication environment (a communication rate) between the sensor unit 10 and the computing device 20.

With the configuration explained above, when the communication environment with the computing device 20 is good, the sensor unit 10 can continue to transmit measurement data to the computing device 20 substantially on a real-time basis in a state in which a space is always present in the transmission buffer 152 (the N-stage FIFO). On the other hand, when the communication environment with the computing device 20 is bad, although a space is absent in the transmission buffer 152 (the N-stage FIFO), since measurement data is stored in the FIFO configured in the storing section 16, the sensor unit 10 can transmit necessary all measurement data to the computing device 20 even if a delay is large.

The computing device 20 includes a processing section 21, a communication section 22, an operation section 23, a storing section 24, a display section 25, and a sound output section 26.

The communication section 22 performs, for example, processing for receiving measurement data transmitted from the sensor unit 10 and sending the measurement data to the processing section 21 and processing for receiving a control command from the processing section 21 and transmitting the control command to the sensor unit 10.

The operation section 23 performs processing for acquiring operation data from the user 2 and sending the operation data to the processing section 21. The operation section 23 may be, for example, a touch panel display, a button, a key, a microphone, or the like.

The storing section 24 is configured by, for example, a storage medium such as various IC memories including a ROM (Read Only Memory), a flash ROM, and a RAM (Random Access Memory), a hard disk, and a memory card.

The storing section 24 has stored therein a computer program for the processing section 21 to perform various kinds of calculation processing and control processing, various computer programs and data for implementing application functions, and the like. In particular, in this embodiment, in the storing section 24, a motion measuring program 240 read out by the processing section 21 to execute measurement processing for a swing motion of the user 2 is stored. The motion measuring program 240 may be stored in a nonvolatile recording medium in advance. Alternatively, the processing section 21 may receive the motion measuring program 240 from a server via a network and cause the storing section 24 to store the motion measuring program 240.

In the storing section 24, club specification information 242 representing specifications of the golf club 3 and sensor mounting position information 244 may be stored. For example, the user 2 operates the operation section 23 to input a model number of the golf club 3, which the user 2 uses, (or selects the model number from a model number list) and sets, as the club specification information 242, specification information of the input model number among specification information (e.g., information such as the length of the shaft, the position of the center of gravity, a lie angle, a face angle, and a loft angle) for each model number stored in the storing section 24 in advance. For example, the user 2 may operate the operation section 23 to input a distance between a mounting position of the sensor unit 10 and the grip of the golf club 3. Information concerning the input distance may be stored in the storing section 24 as the sensor mounting position information 244. Alternatively, assuming that the sensor unit 10 is mounted on a predetermined position (e.g., a distance of 20 cm from the grip end), information concerning the predetermined position may be stored as the sensor mounting position information 244 in advance.

The storing section 24 is used as a work region of the processing section 21 and temporarily stores, for example, data input from the operation section 23 and results of calculations executed by the processing section 21 according to various computer programs. Further, the storing section 24 may store data that needs to be stored for a long time among data generated by processing of the processing section 21.

The display section 25 displays a processing result of the processing section 21 as characters, a graph, a table, an animation, or other images. The display section 25 may be, for example, a CRT, an LCD, a touch panel display, or an HMD (head mounted display). Note that the functions of the operation section 23 and the display section 25 may be implemented by one touch panel display.

The sound output section 26 outputs the processing result of the processing section 21 as voice or various kinds of sound. The sound output section 26 may be, for example, a speaker or a buzzer.

The processing section 21 performs, according to various computer programs, processing for transmitting a control command to the sensor unit 10, various kinds of calculation processing for measurement data received from the sensor unit 10 via the communication section 22, and other various kinds of control processing. In particular, in this embodiment, the processing section 21 executes the motion measuring program 240 to thereby function as a data acquiring section 210, a standstill-period detecting section 211, a zero-point-bias calculating section 212, a motion-end detecting section 213, a motion analyzing section 214, a sensor control section 215, a storage processing section 216, a display processing section 217, and a sound-output processing section 218.

The data acquiring section 210 performs processing for acquiring measurement data received by the communication section 22 from the sensor unit 10 and sending the measurement data to the storage processing section 216.

The storage processing section 216 performs processing for receiving the measurement data from the data acquiring section 210 and causing the storing section 24 to store the measurement data.

The standstill-period detecting section 211 performs processing for detecting, on the basis of the measurement data measured by the sensor unit 10 at the first sampling rate, the standstill period in which the user 2 stands still in S3 in FIG. 3. The standstill-period detecting section 211 may detect the standstill period when the measurement data (three-axis acceleration data and three-axis angular velocity data) is within a predetermined range in a predetermined time (e.g., one second).

When the standstill-period detecting section 211 detects the standstill period, the zero-point-bias calculating section 212 performs processing for calculating a zero-point bias value of the measurement data of the sensor unit 10. The zero-point-bias calculating section 212 may calculate an average of the measurement data in the standstill period (averages of the three-axis acceleration data and averages of the three-axis angular velocity data) and set the average as the zero-point bias value.

The motion-end detecting section 213 performs processing for detecting an end of the swing motion of the user 2 (the action in S5 in FIG. 3) on the basis of the measurement data measured by the sensor unit 10 at the second sampling rate. For example, the motion-end detecting section 213 may detect, as the end of the swing motion, a state in which the user 2 stands still after impact (a standstill state after follow-through).

The motion analyzing section 214 performs processing for analyzing the swing motion of the user 2 (the action in S5 in FIG. 3) using the measurement data measured by the sensor unit 10 at the second sampling rate.

In this embodiment, the motion analyzing section 214 performs processing for detecting timings of actions in the swing motion of the user 2 (measurement time of the measurement data) using the measurement data measured at the second sampling rate. Specifically, first, the motion analyzing section 214 detects timing of impact using the measurement data. Subsequently, the motion analyzing section 214 detects, using measurement data earlier than the timing of the impact, timing when a direction of swing is switched (timing at the top when a backswing is switched to a downswing). Subsequently, the motion analyzing section 214 detects start timing of the swing using measurement data earlier than the timing when the direction of the swing is switched. For example, the motion analyzing section 214 may calculate a combined value of measurement data (acceleration data or angular velocity data) and detect the timings of the impact, the top, and the swing start using the combined value. As the combined value of angular velocity, a square root of a sum of squares of angular velocities around the axes, a sum of squares of the angular velocities around the axes, a sum of the angular velocities around the axes or an average of the sum, a product of the angular velocities around the axes, or the like may be used. Similarly, as the combined value of acceleration, a square root of a sum of squares of accelerations in the axial directions, a sum of squares of the accelerations in the axial directions, a sum of the squares of the accelerations in the axial directions or an average of the sum, a product of the accelerations in the axial directions, or the like may be used.

The motion analyzing section 214 calculates a position and a posture (a posture angle) (a position and a posture in the XYZ coordinate system (the global coordinate system)) of the sensor unit 10 in the swing motion of the user 2 using the measurement data measured at the second sampling rate. Specifically, the motion analyzing section 214 performs bias correction of measurement data (three-axis acceleration data and three-axis angular velocity data) corresponding to the swing motion of the user 2 (the action in S5 in FIG. 3) using the zero-point bias value calculated by the zero-point-bias calculating section 212 and calculates a position and a posture (a posture angle) of the sensor unit 10 during the swing motion of the user 2.

For example, the motion analyzing section 214 calculates a position (an initial position) of the sensor unit 10 during standstill (during address) of the user 2 in the XYZ coordinate system (the global coordinate system) using the thee-axis acceleration data, the club specification information 242, and the sensor amounting position information 244. Thereafter, the motion analyzing section 214 integrates the acceleration data and calculates a change in the position from the initial position of the sensor unit 10 in time series.

Since the user 2 performs the action in S3 in FIG. 3, an X coordinate of the initial position of the sensor unit 10 is 0. Further, as shown in FIG. 2, the y axis of the sensor unit 10 coincides with the major axis direction of the shaft of the golf club 3. During the standstill of the user 2, the acceleration sensor 11 measures only gravitational acceleration. Therefore, the motion analyzing section 214 can calculate an inclination angle (a tilt with respect to the horizontal plane (the XY plane) or the vertical plane (the XZ plane)) of the shaft using y-axis acceleration data. The motion analyzing section 214 calculates a distance LSH between the sensor unit 10 and the head from the club specification information 242 (the length of the shaft) and the sensor mounting position information 244 (the distance from the grip). For example, with the position of the head set as the origin (0, 0, 0), the motion analyzing section 214 sets, as the initial position of the sensor unit 10, a position away from the origin by the distance LSH in the negative direction of the y axis of the sensor unit 10 specified by the inclination angle of the shaft.

The motion analyzing section 214 calculates a posture (an initial posture) of the sensor unit 10 during the standstill (during the address) of the user 2 in the XYZ coordinate system (the global coordinate system) using the acceleration data calculated by the acceleration sensor 11. Thereafter, the motion analyzing section 214 integrates the angular velocity data (rotation operation) and calculates a change in the posture from the initial posture of the sensor unit 10 in time series. The posture of the sensor unit 10 can be represented by, for example, rotation angles (a roll angle, a pitch angle, and a yaw angle) around the X axis, the Y axis, and the Z axis and a quaternion. During the standstill of the user 2, since the acceleration sensor 11 calculates only gravitational acceleration, the motion analyzing section 214 can specify angles formed by the respective x, y, and z axes of the sensor unit 10 and the center of gravity direction using the three-axis acceleration data. Further, since the user 2 performs the action in step S3 in FIG. 3, during the standstill of the user 2, the y axis of the sensor unit 10 is present on the YZ plane. Therefore, the motion analyzing section 214 can specify the initial posture of the sensor unit 10.

The motion analyzing section 214 performs processing for analyzing the swing motion of the user 2 using the detected actions and the position and the posture of the sensor unit 10 and generating analysis information, which is a result of the analysis.

For example, the motion analyzing section 214 may calculate positions of the head and the grip end of the golf club 3 during the swing motion of the user 2 in time series and generate information of a locus of the golf club 3 (tracks of the head and the grip end) based on the calculation result. The motion analyzing section 214 may set, as the position of the head at each time of the swing, a position apart by the distance LSH from the position of the sensor unit 10 at the time in the positive direction of the y axis of the sensor unit 10 specified by the posture of the sensor unit 10 at the time. The motion analyzing section 214 may set, as the position of the grip end at each time of the swing, a position apart by a distance LSG between the sensor unit 10 and the grip end, which is specified by the sensor mounting position information 244 (the distance from the grip end), from the position of the sensor unit 10 at the time in the negative direction of the y axis of the sensor section 10 specified by the posture of the sensor unit 10 at the time. For example, the motion analyzing section 214 may connect positions (coordinates) of the head from the start of the swing to the impact time with lines in order and similarly connect positions (coordinates) of the grip end from the start of the swing to the impact time with lines in order using time series information of the positions of the head and the grip end of the golf club 3 to thereby generate locus information (the locus information shown in FIG. 4) including a locus of the head and a locus of the grip end from the start of the swing to the impact time.

For example, the motion analyzing section 214 may generate, from the timings of the actions in the swing motion of the user 2, information concerning a swing tempo including a part or all of information such as time of the backswing, time in a top section, time of the downswing, and time of the follow-through. The motion analyzing section 214 may calculate a ratio of the time of the backswing and the time of the downswing and a ratio of the time of the top section (time of power accumulation at the top) and the time of the downswing and generate information concerning swing rhythm including information concerning the ratios.

Besides, the motion analyzing section 214 may generate, using the information concerning the positions and the postures of the head and the grip end, for example, information such as head speed and grip speed at the impact time, an incident angle (a club path) and a face angle of the head at the impact time, shaft rotation (a change amount of the face angle during the swing), and a deceleration ratio of the head or information concerning fluctuation in these kinds of information at the time when the user 2 performs a plurality of times of the swing.

The sensor control section 215 performs processing for generating various control commands for the sensor unit 10 and sending the control commands to the communication section 22. Specifically, when receiving operation data corresponding to the measurement start operation (S1 in FIG. 4) by the user 2 from the operation section 23, the sensor control section 215 generates a measurement start command and sends the measurement start command to the communication section 22. When receiving operation data corresponding to the measurement end operation by the user 2 from the operation section 23, the sensor control section 215 generates a measurement end command and sends the measurement end command to the communication section 22. When the standstill-period detecting section 211 detects a standstill period, the sensor control section 215 generates a high-rate setting command and sends the high-rate setting command to the communication section 22. When the motion-end detecting section 213 detects an end of the swing motion, the sensor control section 215 generates a low-rate setting command and sends the low-rate setting command to the communication section 22.

The storage processing section 216 performs processing for reading and writing various computer programs and various data in and from the storing section 24. The storage processing section 216 performs, besides processing for causing the storing section 24 to store the measurement data received from the data acquiring section 210, processing for causing the storing section 24 to store the various kinds of information and the like calculated by the motion analyzing section 214.

The display processing section 217 performs processing for causing the display section 25 to display various images (e.g., images corresponding to the analysis information generated by the motion analyzing section 214). For example, after the swing motion of the user 2 ends, the display processing section 217 may cause, automatically or according to input operation of the user 2, the display section 25 to display the image corresponding to the analysis information. Note that a display section may be provided in the sensor unit 10. The display processing section 217 may transmit image data to the sensor unit 10 via the communication section 22 and cause the display section of the sensor unit 10 to display various images, characters, and the like.

The sound-output processing section 218 performs processing for causing the sound output section 26 to output voice and various kinds of sound. For example, when the user 2 performs the measurement start operation, the sound-output processing section 218 may cause the sound output section 26 to output voice for instructing the user 2 to take the address posture (e.g., “please stands still for one second or more in the address posture”). Further, when the motion-end detecting section 213 detects the end of the swing motion of the user 2, after a predetermined time elapses, the sound-output processing section 218 may cause the sound output section 26 to output the voice for instructing the user 2 to take the address posture. When the standstill-period detecting section 211 detects the standstill period, the sound-output processing section 218 may cause the sound output section 26 to output voice for permitting the user 2 to perform swing (e.g., “please swing”). Besides, after the swing motion of the user 2 ends, the sound-output processing section 218 may cause, automatically or according to input operation of the user 2, the sound output section 26 to output sound or voice corresponding to analysis information. Note that a sound output section may be provided in the sensor unit 10. The sound-output processing section 218 may transmit various sound data and voice data to the sensor unit 10 via the communication section 22 and cause the sound output section of the sensor unit 10 to output various kinds of sound and voice.

Besides, a light emitting section or a vibrating mechanism may be provided in the computing device 20 or the sensor unit 10. Various kinds of information may be converted into optical information or vibration information by the light emitting section or the vibrating mechanism and notified to the user 2.

### 1-1-3. Processing of the Motion Measuring System Time Chart

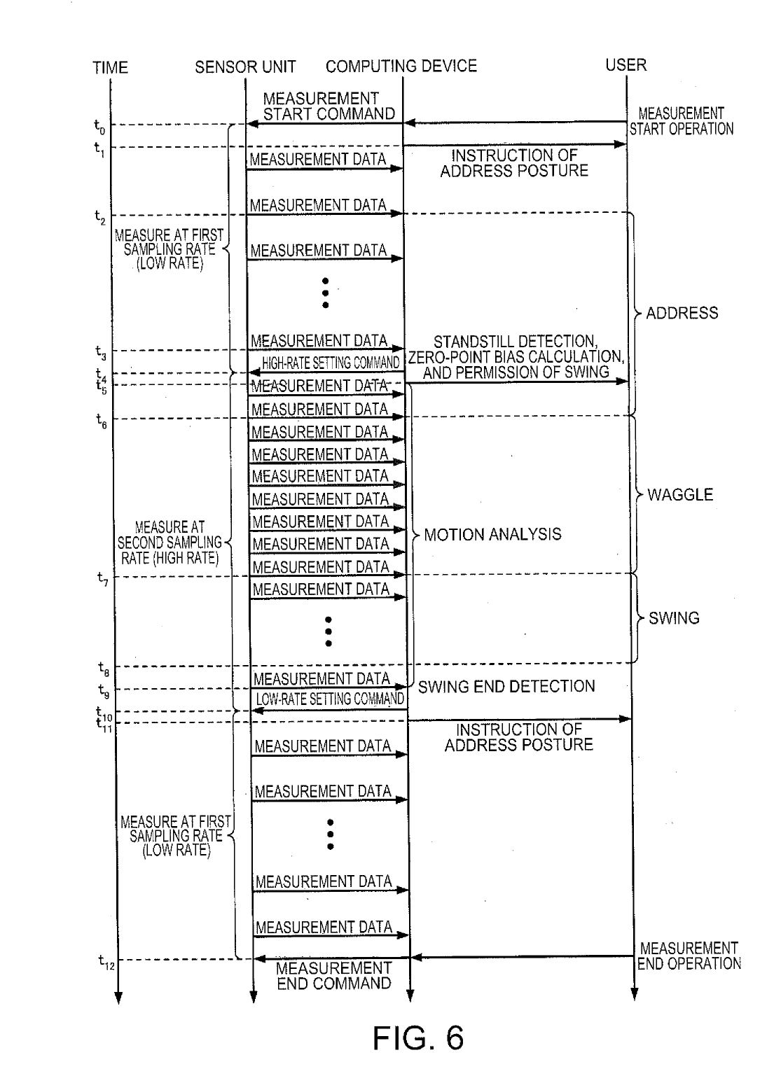

FIG. 6 is a diagram showing an example of a time chart of actions of the user 2, processing of the sensor unit 10, and processing of the computing device 20 in the first embodiment. In the example shown in FIG. 6, at time t0, the computing device 20 transmits a measurement start command to the sensor unit 10 according to the measurement start operation performed by the user 2. The sensor unit 10 receives the measurement start command, starts measurement at the first sampling rate (a low rate), and sequentially transmits measurement data to the computing device 20.

At time t1, the computing device 20 gives the user 2 notification for instructing the user 2 to take the address posture. The user 2 receives the notification and stands still in the address posture from time t2.

At time t3, the computing device 20 detects a predetermined standstill period and performs zero-bias point calculation using measurement data measured at the first sampling rate (the low rate) in the standstill period.

At time t4, the computing device 20 transmits a high-rate setting command to the sensor unit 10. The sensor unit 10 receives the high-rate setting command, switches the measurement to measurement at the second sampling rate (a high rate), and sequentially transmits measurement data to the computing device 20.

At time t5, the computing device 20 gives the user 2 notification for permitting the user 2 to perform swing. The user 2 receives the notification and, after performing waggle from time t6, performs the swing motion (the backswing, the downswing, and the follow-through) between time t7 and time t8.

The computing device 20 performs an analysis of the swing motion using the measurement data measured at the second sampling rate (the high rate). At time t9, the computing device 20 detects an end of the swing motion.

At time t10, the computing device 20 transmits a low-rate setting command to the sensor unit 10. The sensor unit 10 receives the low-rate setting command, switches the measurement to the measurement at the first sampling rate (the low rate), and sequentially transmits measurement data to the computing device 20.

At time t11, the computing device 20 gives the user 2 notification for instructing the user 2 to take the address posture.

After time t11, the user 2 may repeatedly perform a series of actions (address, waggle, and swing) same as the actions performed at time t2 to time t8. The sensor unit 10 and the computing device 20 repeatedly perform processing same as the processing at time t2 to time t11 according to the respective series of actions of the user 2.

Thereafter, at time t12, the computing device 20 transmits a measurement end command to the sensor unit 10 according to measurement end operation performed by the user 2 and ends the processing. The sensor unit 10 receives the measurement end command and ends the measurement.

In order to set time in which the user 2 stands still in the address posture (time t2 to time t6 in FIG. 6) as short as possible to improve convenience, the computing device 20 needs to perform the detection of the standstill period on a real-time basis as much as possible. Therefore, it is preferable to set the first sampling rate to be equal to or lower than an output rate at which the sensor unit 10 outputs measurement data (a transmission rate of measurement data from the sensor unit 10 to the computing device 20). Further, the computing device 20 calculates a zero-point bias value using measurement data in the standstill period. However, since fluctuation in the measurement data is small during the standstill of the user 2, the number of the measurement data may be small. Therefore, it is more preferable to set the first sampling rate as low as possible in a range in which the computing device 20 does not detect the standstill period by mistake.

On the other hand, the fluctuation in the measurement data is large during the swing motion of the user 2 (time t7 to time t8 in FIG. 6). Therefore, in order to accurately perform a motion analysis, the second sampling rate is desirably high. During the swing motion of the user 2, necessity of the computing device 20 to receive the measurement data on a real-time basis without delay is not high. Therefore, the second sampling rate may be set higher than the output rate of the sensor unit 10 (the transmission rate of the measurement data from the sensor unit 10 to the computing device 20).

Taking into account such a situation, in this embodiment, the first sampling rate is set lower than the second sampling rate. For example, when the output rate (the transmission rate) of the sensor unit 10 is 500 Hz, the first sampling rate may be set to 250 Hz or less (a half or less of the output rate (the transmission rate)) and the second sampling rate may be set to 1 kHz or more (a double or more of the output rate (the transmission rate)). If the first sampling rate and the second sampling rate are set in this way, while the user 2 stands still in the address posture, even if retransmission of measurement data due to a transmission error or the like occurs to a certain degree, the computing device 20 can perform the detection of the standstill period on a real-time basis. While the user 2 is performing the swing motion, the computing device 20 can acquire a large number of measurement data and accurately perform the motion analysis.

### Processing Procedure of the Computing Device

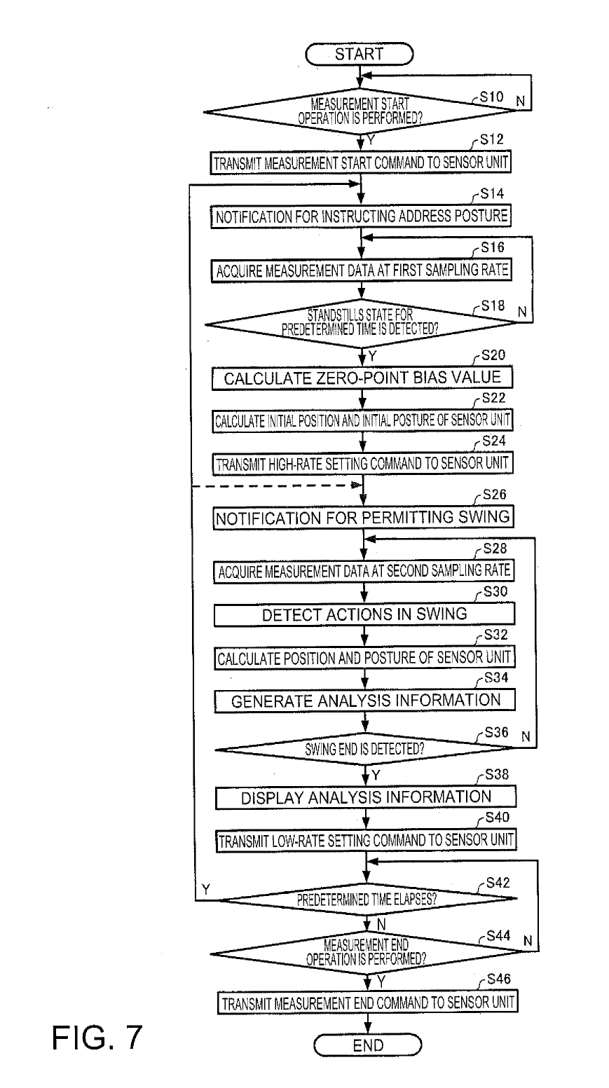

FIG. 7 is a flowchart for explaining a procedure of motion measurement processing by the processing section 21 of the computing device 20 in the first embodiment. The processing section 21 of the computing device 20 (an example of a computer) executes the motion measuring program 240 stored in the storing section 24 to thereby execute the motion measurement processing according to the procedure of the flowchart of FIG. 7. The flowchart of FIG. 7 is explained below.

First, the processing section 21 stays on standby until measurement start operation by the user 2 is performed (N in S10). When the measurement start operation is performed (Y in S10), the processing section 21 transmits a measurement start command to the sensor unit 10 via the communication section 22 (S12).

The processing section 21 performs, with voice or the like, notification for instructing the user 2 to take the address posture (S14).

Subsequently, the processing section 21 acquires measurement data measured by the sensor unit 10 at the first sampling rate (S16).

Subsequently, the processing section 21 repeats the processing (S16) for acquiring new measurement data until the processing section 21 detects a state in which the user 2 continuously stands still for a predetermined time (N in S18). When detecting the standstill state (a standstill period) in the predetermined time (Y in S18), the processing section 21 calculates a zero-point bias value using measurement data corresponding to the standstill period (S20).

The processing section 21 calculates an initial position and an initial posture of the sensor unit 10 using the measurement data corresponding to the standstill period acquired in step S16, the club specification information 242, the sensor mounting position information 244, and the like (S22).

The processing section 21 transmits a high-rate setting command to the sensor unit 10 via the communication section 22 (S24).

Further, the processing section 21 performs, with voice or the like, notification for permitting the user 2 to perform swing (S26). Alternatively, an LED may be provided in the sensor unit 10. The processing section 21 may perform control for, for example, lighting the LED via the communication section 22 and perform the notification for permitting the user 2 to perform swing.

Subsequently, the processing section 21 acquires measurement data measured by the sensor unit 10 at the second sampling rate (S28).

Subsequently, the processing section 21 detects actions in the swing using the measurement data acquired in step S28 (S30).

The processing section 21 calculates a position and a posture of the sensor unit 10 using the measurement data acquired in step S28 (S32).

Subsequently, the processing section 21 analyzes the swing motion of the user 2 using a detection result of the actions in step S30, the position and the posture of the sensor unit 10 calculated in step S32, and the like and generates analysis information, which is a result of the analysis (S34). In step S34, the processing section 21 generates, for example, analysis information of rhythm and a tempo of the swing and analysis information of loci of the head and the grip end of the golf club 3 and head speed and grip speed at impact time.

Subsequently, the processing section 21 repeats the processing in steps S28 to S34 until the processing section 21 detects a state in which the user 2 ends the swing motion (a standstill state after the impact) (N in S36). When detecting an end of the swing motion (Y in S36), the processing section 21 causes the display section 25 to display the analysis information generated in step S34 (S38).

The processing section 21 transmits a low-rate setting command to the sensor unit 10 via the communication section 22 (S40).

If measurement end operation by the user 2 is not performed before a predetermined time elapses (Y in S42), the processing section 21 performs the processing in steps S14 to S40 again (alternatively, the processing section 21 may perform the processing in steps S26 to S40).

On the other hand, when the measurement end operation by the user 2 is performed before the predetermined time elapses (N in S42 and Y in S44), the processing section 21 transmits a measurement end command to the sensor unit 10 via the communication section 22 (S46) and ends the processing.

Note that, in the flowchart of FIG. 7, the order of the steps may be changed as appropriate if possible.

### Processing Procedure of the Sensor Unit

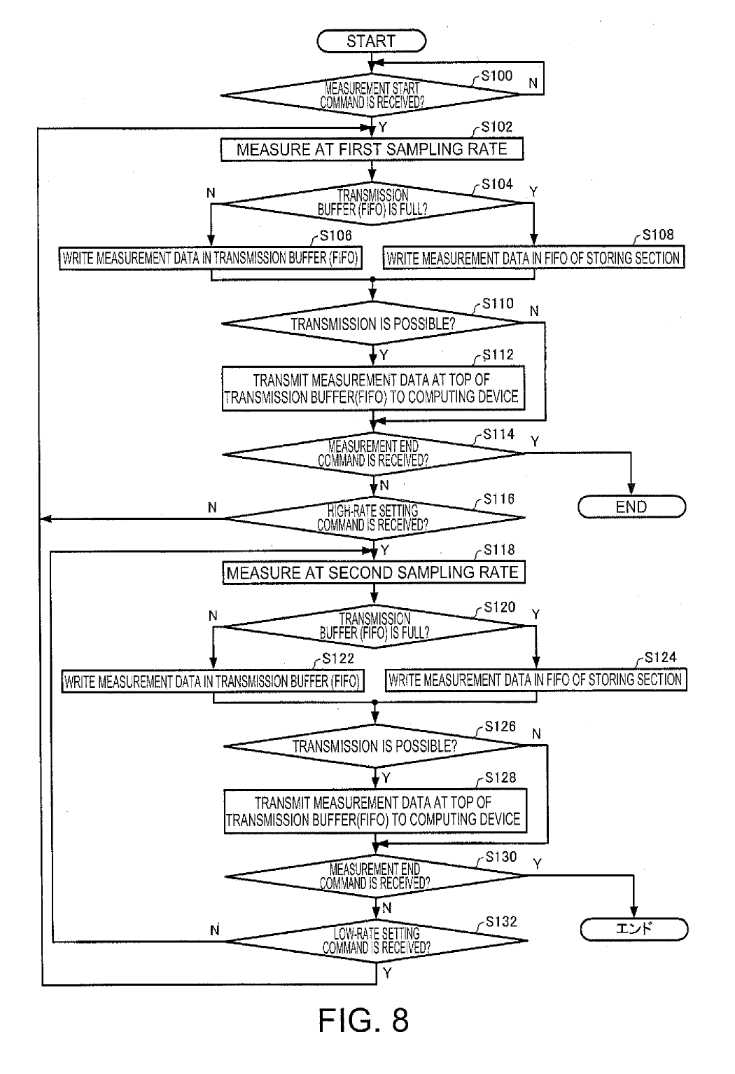

FIG. 8 is a flowchart for explaining a procedure of measurement processing of the sensor unit 10 in the first embodiment. The flowchart of FIG. 8 is explained below.

First, the sensor unit 10 stays on standby until the sensor unit 10 receives a measurement start command from the computing device 20 (N in S100). When receiving the measurement start command (Y in S100), the sensor unit 10 performs measurement (acquires three-axis acceleration data and three-axis angular velocity data) at the first sampling rate (S102).

Subsequently, if the transmission buffer 152 (the N-stage FIFO) is not full (N in S104), the sensor unit 10 writes measurement data obtained by the measurement in step S102 in the transmission buffer 152 (the N-stage FIFO) (S106). If the transmission buffer 152 (the N-stage FIFO) is full (Y in S104), the sensor unit 10 writes the measurement data obtained by the measurement in step S102 in the FIFO configured in the storing section 16 (S108).

Subsequently, if transmission is possible (Y in S110), the sensor unit 10 transmits measurement data at the top of the transmission buffer 152 (the N-stage FIFO) to the computing device 20 (S112).

The sensor unit 10 repeats the processing in steps S102 to S112 until the sensor unit 10 receives a measurement end command or a high-rate setting command from the computing device 20 (N in S114 and N in S116).

When receiving the measurement end command (Y in S114), the sensor unit 10 ends the measurement processing.

When receiving the high-rate setting command (Y in S116), the sensor unit 10 performs measurement (acquires three-axis acceleration data and three-axis angular velocity data) at the second sampling rate (S118).

Subsequently, if the transmission buffer 152 (the N-stage FIFO) is not full (N in S120), the sensor unit 10 writes measurement data obtained by the measurement in step S118 in the transmission buffer 152 (the N-stage FIFO) (S122). If the transmission buffer 152 (the N-stage FIFO) is full (Y in S120), the sensor unit 10 writes the measurement data obtained by the measurement in step S118 in the FIFO configured in the storing section 16 (S124).

Subsequently, if transmission is possible (Y in S126), the sensor unit 10 transmits measurement data at the top of the transmission buffer 152 (the N-stage FIFO) to the computing device 20 (S128).

The sensor unit 10 repeats the processing in steps S118 to S128 until the sensor unit 10 receives the measurement end command or the low-rate setting command from the computing device 20 (N in S130 and N in S132).

When receiving the measurement end command (Y in S130), the sensor unit 10 ends the measurement processing.

When receiving the low-rate setting command (Y in S132), the sensor unit 10 performs the processing in step S102 and subsequent steps again.

Note that, in the flowchart of FIG. 8, the order of the steps may be changed as appropriate if possible.

### 1-1-4. Effects

As explained above, in the first embodiment, focusing on the fact that an amount of measurement data may be reduced because fluctuation in the measurement data is small in the standstill period in which the user 2 hardly moves, in the standstill period of the user 2, the sensor unit 10 performs measurement at the first sampling rate lower than the second sampling rate in the swing motion period of the user 2. Therefore, according to the first embodiment, by reducing an amount of measurement data in the standstill period of the user 2, the computing device 20 can acquire the measurement data on a real-time basis and reduce time required for detection of the standstill period of the user 2.

In the first embodiment, in order to acquire a sufficient amount of measurement data in the motion period of the user 2, in the swing motion period of the user 2, the sensor unit 10 performs measurement at the second sampling rate higher than the first sampling rate in the standstill period of the user 2. Therefore, according to the first embodiment, the computing device 20 can acquire a sufficient amount of measurement data in the swing motion period of the user 2. Therefore, the computing device 20 can accurately analyze the swing motion of the user 2 on the basis of the measurement data.

### 1-2. Second Embodiment

### 1-2-1. Overview of the Motion Measuring System

As in the first embodiment, the motion measuring system 1 in a second embodiment includes the sensor unit 10 and the computing device 20. In the second embodiment, the sensor unit 10 has two output modes: a buffering mode and a real-time mode.

The buffering mode is a mode for writing new measurement data in the transmission buffer 152 (the N-stage FIFO) if the transmission buffer 152 (the N-stage FIFO) is not full and writing the new measurement data in the FIFO configured in the storing section 16 if the transmission buffer 152 (the N-stage FIFO) is full. That is, in the buffering mode, the sensor unit 10 performs operation same as the operation in the first embodiment.

On the other hand, the real-time mode is a mode for writing new measurement data in the transmission buffer 152 (the N-stage FIFO) if the transmission buffer 152 (the N-stage FIFO) is not full and, if the transmission buffer 152 (the N-stage FIFO) is full, shifting the transmission buffer 152 (the N-stage FIFO) by one stage and discarding data at the top to form a space and writing (overwriting) the new measurement data in the transmission buffer 152 (the N-stage FIFO).

In the second embodiment, the sensor unit 10 is set in the real-time mode when performing measurement at the first sampling rate (e.g., 250 Hz) and is set in the buffering mode when performing measurement at the second sampling rate (e.g., 1 kHz).

Specifically, in the second embodiment, the sensor unit 10 starts measurement at the first sampling rate according to the measurement start operation of the user 2 in S1 in FIG. 3. In the standstill period (an example of the standstill period of the measurement object) in which the user stands still in S3 in FIG. 3, the sensor unit 10 performs measurement at the first sampling rate and transmits measurement data (an example of the first measurement data) to the computing device in the real-time mode (an example of the first-measurement-data output step).

The computing device 20 receives the measurement data at the first sampling rate and detects a predetermined standstill period (e.g., a standstill period of one second) of the user 2 on the basis of the measurement data (an example of the standstill-period detecting step). When detecting the standstill period of the user 2, the computing device 20 transmits, to the sensor unit 10, a high-rate and buffering mode setting command (an example of the first switching signal) for instructing switching to the second sampling rate and the buffering mode (an example of the first switching-signal transmitting step).

The sensor unit 10 receives the high-rate and buffering mode setting command and switches the sampling rate to the second sampling rate and switches the output mode to the buffering mode on the basis of the command (an example of the first sampling-rate switching step). In a period of the switching motion of the user 2 in S5 in FIG. 3 (an example of the motion period of the measurement object), the sensor unit 10 performs measurement at the second sampling rate and transmits measurement data (an example of the second measurement data) to the computing device 20 in the buffering mode (an example of the second-measurement-data output step).

The computing device 20 receives the measurement data at the second sampling rate and analyzes the swing motion of the user 2 using the measurement data (an example of the motion analyzing step).

Further, the computing device 20 receives the measurement data at the second sampling rate and detects an end of the swing motion of the user 2 (an example of the motion-end detecting step). When detecting the end of the swing motion of the user 2, the computing device 20 transmits, to the sensor unit 10, a low-rate and real-time mode setting command (an example of the second switching signal) for instructing switching to the first sampling rate and the real-time mode (an example of the second-switching-signal transmitting step).

The sensor unit 10 receives the low-rate and real-time mode setting command and switches the sampling rate to the first sampling rate and switches the output mode to the real-time mode on the basis of the command (an example of the second-sampling-rate switching step).

### 1-2-2. Configuration of the Motion Measuring System

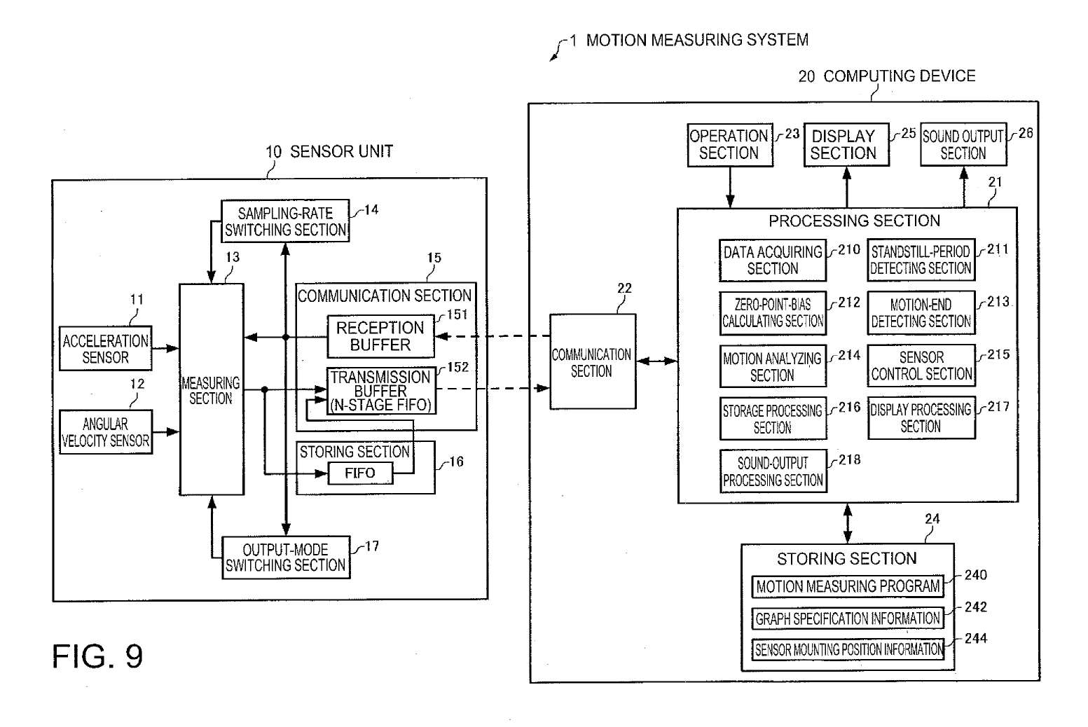

FIG. 9 is a diagram showing a configuration example of the motion measuring system 1 (a configuration example of the sensor unit 10 and the computing device 20) in the second embodiment. In FIG. 9, components same as the components shown in FIG. 5 are denoted by the same reference numerals. In the following explanation, explanation overlapping with the explanation in the first embodiment is omitted or simplified.

The sensor unit 10 in the second embodiment includes components same as the components in the first embodiment. An output-mode switching section 17 is added to the sensor unit 10.

The output-mode switching section 17 switches the output mode to the real-time mode or the buffering mode. Specifically, when receiving the high-rate and buffering mode setting command from the communication section 15, the output-mode switching section 17 switches the output mode to the buffering mode. When receiving the low-rate and real-time mode setting command from the communication section 15, the output-mode switching section 17 switches the output mode to the real-time mode.

The sampling-rate switching section 14 switches the sampling rate at which the measuring section 13 performs measurement (acquires three-axis acceleration data and three-axis angular velocity data). Specifically, when receiving the high-rate and buffering mode setting command from the communication section 15, the sampling-rate switching section 14 switches the sampling rate of the measuring section 13 to the second sampling rate (e.g., 1 kHz). When receiving the low-rate and real-time mode setting command from the communication section 15, the sampling-rate switching section 14 switches the sampling rate of the measuring section 13 to the first sampling rate.

The configuration of the computing device 20 in the second embodiment is the same as the configuration in the first embodiment. However, the function of the sensor control section 215 of the processing section 21 is different from the function in the first embodiment.

When the standstill-period detecting section 211 detects the standstill period, the sensor control section 215 in the second embodiment generates the high-rate and buffering mode setting command and sends the high-rate and buffering mode setting command to the communication section 22. When the motion-end detecting section 213 detects the end of the swing motion of the user 2, the sensor control section 215 generates the low-rate and real-time mode setting command and sends the low-rate and real-time mode setting command to the communication section 22.

As in the first embodiment, when receiving the operation data corresponding to the measurement start operation from the operation section 23, the sensor control section 215 in the second embodiment generates the measurement start command and sends the measurement start command to the communication section 22. When receiving the operation data corresponding to the measurement end operation from the operation section 23, the sensor control section 215 generates the measurement end command and sends the measurement end command to the communication section 22.

### 1-2-3. Processing of the Motion Measuring System

### Time Chart

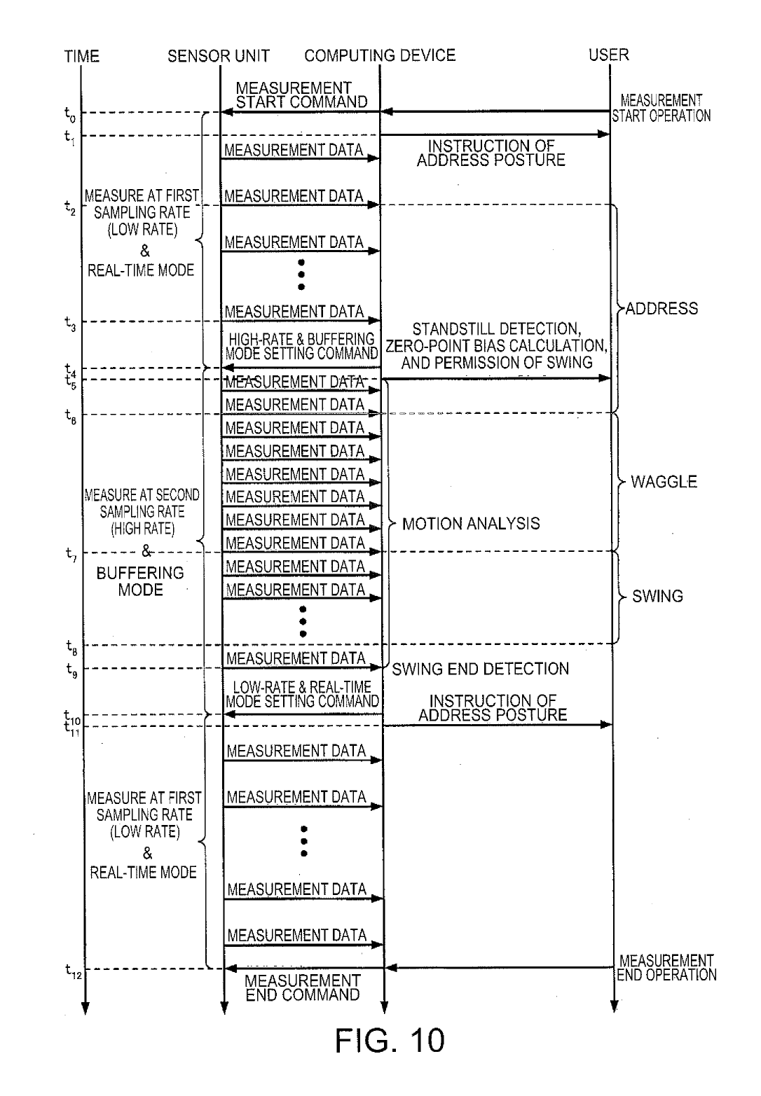

FIG. 10 is a diagram showing an example of a time chart of actions of the user 2, processing of the sensor unit 10, and processing of the computing device 20 in the second embodiment. In the example shown in FIG. 10, at time t0, the computing device 20 transmits a measurement start command to the sensor unit 10 according to the measurement start operation performed by the user 2. The sensor unit 10 receives the measurement start command, starts measurement at the first sampling rate (the low rate), and sequentially transmits measurement data to the computing device 20 in the real-time mode.

At time t1, the computing device 20 gives the user 2 notification for instructing the user 2 to take the address posture. The user 2 receives the notification and stands still in the address posture from time t2.

At time t3, the computing device 20 detects a predetermined standstill period and performs zero-point bias calculation using measurement data measured at the first sampling rate (the low rate) in the standstill period.

At time t4, the computing device 20 transmits a high-rate and buffering mode setting command to the sensor unit 10. The sensor unit 10 receives the high-rate and buffering mode setting command, switches the measurement to measurement at the second sampling rate (the high rate), and sequentially transmits measurement data to the computing device 20 in the buffering mode.

At time t5, the computing device 20 gives the user 2 notification for permitting the user 2 to perform swing. The user 2 receives the notification and, after performing waggle from time t6, performs the swing motion (the backswing, the downswing, and the follow-through) between time t7 and time t8.

The computing device 20 performs an analysis of the swing motion using the measurement data measured at the second sampling rate (the high rate). At time t9, the computing device 20 detects an end of the swing motion.

At time t10, the computing device 20 transmits a low-rate and real-time mode setting command to the sensor unit 10. The sensor unit 10 receives the low-rate and real-time mode setting command, switches the measurement to the measurement at the first sampling rate (the low rate), and sequentially transmits measurement data to the computing device 20 in the real-time mode.

At time t11, the computing device 20 gives the user 2 notification for instructing the user 2 to take the address posture.

After time t11, the user 2 may repeatedly perform a series of actions (address, waggle, and swing) same as the actions performed at time t2 to time t8. The sensor unit 10 and the computing device 20 repeatedly perform processing same as the processing at time t2 to time t11 according to the respective series of actions of the user 2.

Thereafter, at time t12, the computing device 20 transmits a measurement end command to the sensor unit 10 according to measurement end operation performed by the user 2 and ends the processing. The sensor unit 10 receives the measurement end command and ends the measurement.

In the second embodiment, in the sensor unit 10, while the user 2 stands still in the address posture, the sampling rate is set to the first sampling rate and the output mode is set to the real-time mode. In the real-time mode, when the transmission buffer 152 (the N-stage FIFO) is full, the sensor unit 10 always retains, while discarding oldest measurement data, a state in which N or less measurement data is written in the transmission buffer 152 (the N-stage FIFO). In the real-time mode, when transmission is possible, the sensor unit 10 transmits latest measurement data or nearly latest measurement data to the computing device 20. Therefore, the computing device 20 can surely perform the detection of the standstill period on a real-time basis. The computing device 20 calculates a zero-point bias value using the measurement data during the standstill period. However, since fluctuation in the measurement data is small during the standstill of the user 2, even if a part of the measurement data is discarded, the influence of the discarding of the measurement data is small. Therefore, it is possible to surely reduce time (time t2 to time t6 in FIG. 10) when the user 2 stands still in the address posture. It is possible to further improve convenience for the user 2.

On the other hand, during the swing motion of the user 2 (time t7 to time t8 in FIG. 10), in the sensor unit 10, the sampling rate is set to the second sampling rate and the output mode is set in the buffering mode. In the buffering mode, when the transmission buffer 152 (the N-stage FIFO) is full, the sensor unit 10 writes latest measurement data in the FIFO configured in the storing section 16. Therefore, the sensor unit 10 can transmit measurement data necessary for a motion analysis to the computing device 20 without omission.

As explained above, in the second embodiment, while the user 2 stands still in the address posture, even if retransmission of measurement data due to a transmission error or the like frequently occurs, the computing device 20 can perform the detection of the standstill period on a real-time basis. While the user 2 is performing the swing motion, the computing device 20 can acquire a large number of measurement data and accurately perform the motion analysis.

### Processing Procedure of the Computing Device

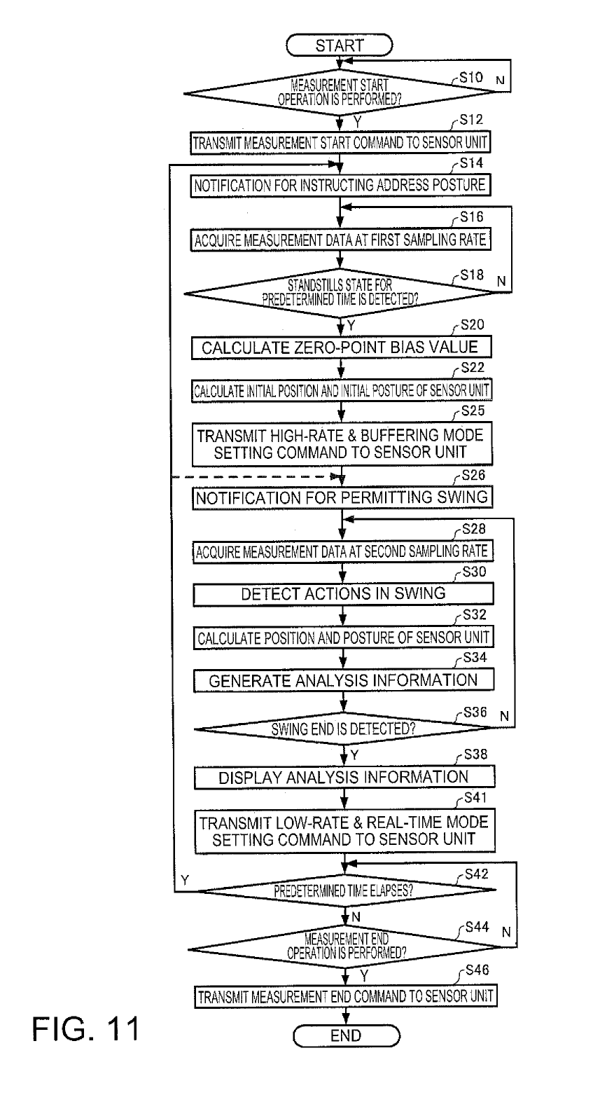

FIG. 11 is a flowchart for explaining a procedure of motion measurement processing by the processing section 21 of the computing device 20 in the second embodiment. In FIG. 11, steps for performing processing same as the processing in FIG. 7 are denoted by the same reference signs. The processing section 21 of the computing device 20 (an example of a computer) executes the motion measuring program 240 stored in the storing section 24 to thereby execute the motion measurement processing according to the procedure of the flowchart of FIG. 11. The flowchart of FIG. 11 is explained below centering on processing different from the processing in the flowchart of FIG. 7.

First, the processing section 21 stays on standby until the measurement start operation by the user 2 is performed (N in S10). When the measurement start operation is performed (Y in S10), as in the first embodiment (FIG. 7), the processing section 21 performs the processing in steps S12 to S22.

Subsequently, the processing section 21 transmits a high-rate and buffering mode setting command to the sensor unit 10 via the communication section 22 (S25).

Subsequently, as in the first embodiment (FIG. 7), the processing section 21 performs the processing in steps S26 to S38.

Subsequently, the processing section 21 transmits a low-rate and real-time mode setting command to the sensor unit 10 via the communication section 22 (S41).

If the measurement end operation by the user 2 is not performed before a predetermined time elapses (Y in S42), the processing section 21 performs the processing in steps S14 to S41 again (or the processing section 21 may perform the processing in steps S26 to S41).

On the other hand, if the measurement end operation by the user 2 is performed before the predetermined time elapses (N in S42 and Y in S44), the processing section 21 transmits a measurement end command to the sensor unit 10 via the communication section 22 (S46) and ends the processing.

Note that, in the flowchart of FIG. 11, the order of the steps may be changed as appropriate if possible.

### Processing Procedure of the Sensor Unit

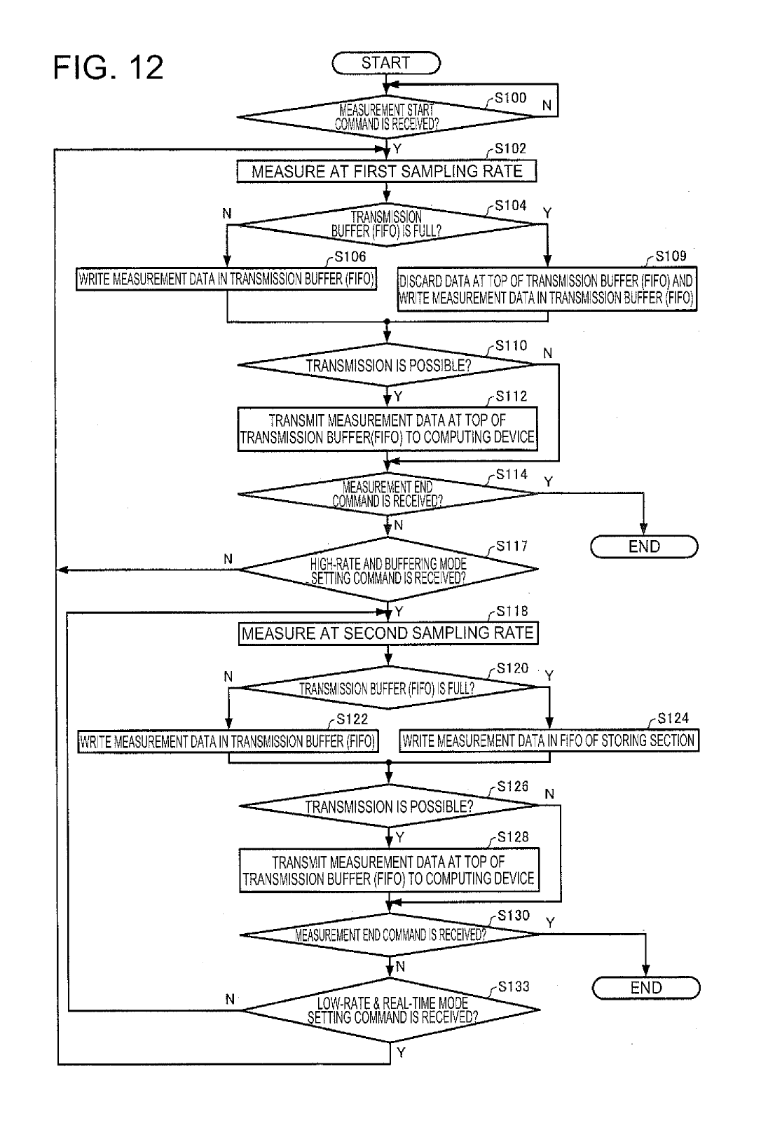

FIG. 12 is a flowchart for explaining a procedure of measurement processing of the sensor unit 10 in the second embodiment. In FIG. 12, steps for performing processing same as the processing in FIG. 8 are denoted by the same reference signs. The flowchart of FIG. 12 is explained below centering on processing different from the processing of the flowchart of FIG. 8.

First, the sensor unit 10 stays on standby until the sensor unit 10 receives a measurement start command from the computing device 20 (N in S100). When receiving the measurement start command (Y in S100), the sensor unit 10 performs measurement (acquires three-axis acceleration data and tree-axis angular velocity data) at the first sampling rate (S102).

Subsequently, if the transmission buffer 152 (the N-stage FIFO) is not full (N in S104), the sensor unit 10 writes measurement data obtained by the measurement in step S102 in the transmission buffer 152 (the N-stage FIFO) (S106). If the transmission buffer 152 (the N-stage FIFO) is full (Y in S104), the sensor unit 10 discards data at the top of the transmission buffer 152 (the N-stage FIFO) and writes the measurement data obtained by the measurement in step S102 in the transmission buffer 152 (the N-stage FIFO) (S109).

Subsequently, if transmission is possible (Y in S110), the sensor unit 10 transmits measurement data at the top of the transmission buffer 152 (the N-stage FIFO) to the computing device 20 (S112).

The sensor unit 10 repeats the processing in steps S102 to S112 until the sensor unit 10 receives a measurement end command or a high-rate and buffering mode setting command from the computing device 20 (N in S114 and N in S117).

When receiving the measurement end command (Y in S114), the sensor unit 10 ends the measurement processing.

When receiving the high-rate and buffering mode setting command (Y in S117), as in the first embodiment (FIG. 8), the sensor unit 10 performs the processing in steps S118 to S128.

The sensor unit 10 repeats the processing in steps S118 to S128 until the sensor unit 10 receives the measurement end command or the low-rate and real-time mode setting command from the computing device 20 (N in S130 and N in S133).

When receiving the measurement end command (Y in S130), the sensor unit 10 ends the measurement processing.

When receiving the low-rate and real-time mode setting command (Y in S133), the sensor unit 10 performs the processing in step S102 and subsequent steps again.

Note that, in the flowchart of FIG. 12, the order of the steps may be changed as appropriate if possible.

### 1-2-4. Effects

According to the second embodiment explained above, effects same as the effects in the first embodiment can be attained. Further, in the standstill period of the user 2, even if the first sampling rate is higher than the transmission rate, the sensor unit 10 can preferentially transmit the latest measurement data to the computing device 20. Therefore, the computing device 20 can detect the standstill period of the user 2 without a delay.

### 1-3. Third Embodiment

### 1-3-1. Overview of the Motion Measuring System

As in the first embodiment, the motion measuring system 1 in a third embodiment includes the sensor unit 10 and the computing device 20. In the third embodiment, while performing measurement at the first sampling rate (e.g., 250 Hz), the sensor unit 10 detects a high-speed action of the user 2 on the basis of measurement data and switches the measurement to measurement at the second sampling rate (e.g., 1 kHz). While performing measurement at the second sampling rate, the sensor unit 10 detects a low-speed action of the user 2 on the basis of measurement data and switches the measurement to measurement at the first sampling rate.

Specifically, in the third embodiment, the sensor unit 10 starts measurement at the first sampling rate according to the measurement start operation of the user 2 in S1 in FIG. 3. In the standstill period in which the user 2 stands still in S3 in FIG. 3 (an example of the standstill period of the measurement object), the sensor unit 10 performs measurement at the first sampling rate and transmits measurement data (an example of the first measurement data) to the computing device 20 (an example of the first-measurement-data output step).

The computing device 20 receives the measurement data at the first sampling rate and detects a predetermined standstill period (e.g., a standstill period of one second) of the user 2 on the basis of the measurement data (an example of the standstill-period detecting step).

The sensor unit 10 detects a high-speed action (e.g., a swing start action) in the swing motion of the user in S5 in FIG. 3 on the basis of the measurement data and switches the sampling rate to the second sampling rate on the basis of a signal of the detection (an example of the first switching signal) (an example of the first-sampling-rate switching step). The sensor unit 10 performs measurement at the second sampling rate in a period of the swing motion of the user 2 in S5 in FIG. 3 (an example of the motion period of the measurement object) and transmits measurement data (an example of the second measurement data) to the computing device 20 (an example of the second-measurement-data output step).

The computing device 20 receives the measurement data at the second sampling rate and analyzes the swing motion of the user 2 using the measurement data (an example of the motion analyzing step).

The sensor unit 10 detects a low-speed action (e.g., a standstill state) after the end of the swing motion of the user in S5 in FIG. 3 on the basis of the measurement data and switches the sampling rate to the first sampling rate on the basis of a signal of the detection (an example of the second switching signal) (an example of the second-sampling-rate switching step).

### 1-3-2. Configuration of the Motion Measuring System

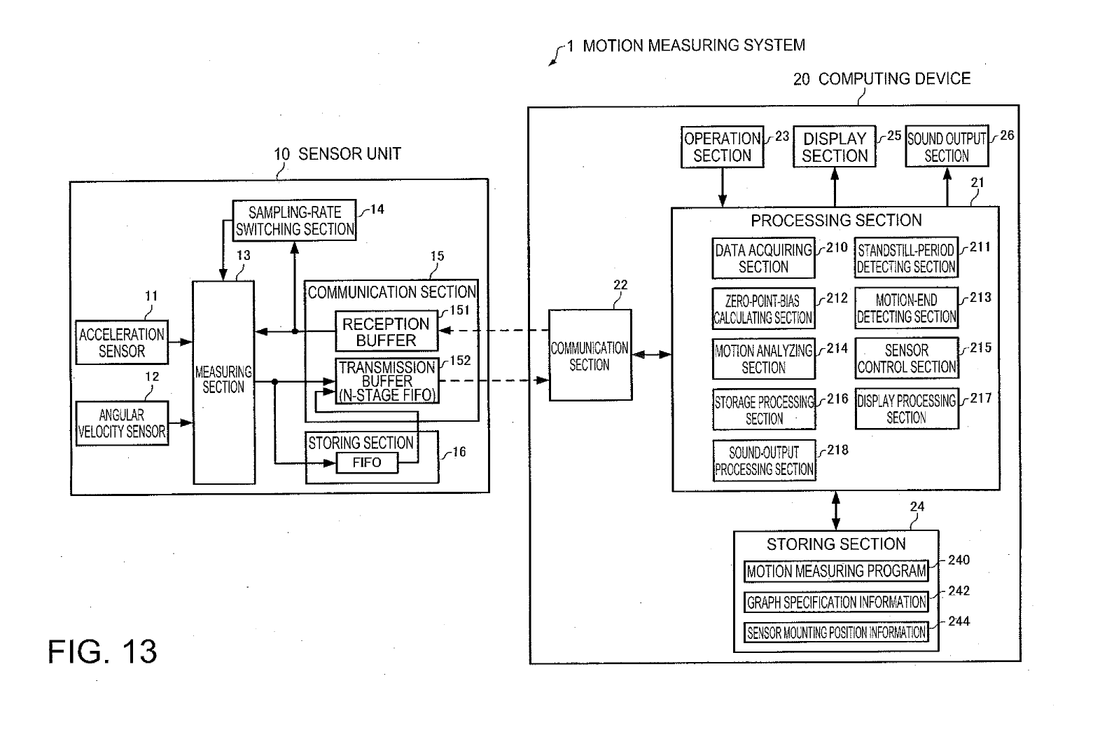

FIG. 13 is a diagram showing a configuration example of the motion measuring system 1 (a configuration example of the sensor unit 10 and the computing device 20) in the third embodiment. In FIG. 13, components same as the components shown in FIG. 5 are denoted by the same reference numerals. In the following explanation, explanation overlapping with the explanation in the first embodiment is omitted or simplified.

The configuration of the sensor unit 10 in the third embodiment includes components same as the components in the first embodiment. However, the configuration of the sampling-rate switching section 14 is different from the configuration in the first embodiment.

The sampling-rate switching section 14 switches a sampling rate at which the measuring section 13 performs measurement (acquires three-axis acceleration data and three-axis angular velocity data). Specifically, when the sampling rate is the first sampling rate, the sampling-rate switching section 14 detects a high-speed action of the user 2 and switches the sampling rate to the second sampling rate when an amount of change of measurement data (e.g., a combined value of three-axis acceleration data or a combined value of three-axis angular velocity data) generated by the measuring section 13 is equal to or larger than a predetermined first threshold. When the sampling rate is the second sampling rate, the sampling-rate switching section 14 detects a low-speed action of the user 2 and switches the sampling rate to the first sampling rate when the amount of change of the measurement data generated by the measuring section 13 is equal to or smaller than a predetermined second threshold.

The configuration of the computing device 20 in the third embodiment is the same as the configuration in the first embodiment. However, the function of the sensor control section 215 of the processing section 21 is different from the function in the first embodiment.

As in the first embodiment, when receiving operation data corresponding to measurement start operation from the operation section 23, the sensor control section 215 in the third embodiment generates a measurement start command and sends the measurement start command to the communication section 22. When receiving operation data corresponding to measurement end operation from the operation section 23, the sensor control section 215 generates a measurement end command and sends the measurement end command to the communication section 22. Unlike the first embodiment, the sensor control section 215 in the third embodiment does not perform the processing for generating a high-rate setting command or a low-rate setting command and sending the command to the communication section 22.

### 1-3-3. Processing of the Motion Measuring System

### Time Chart

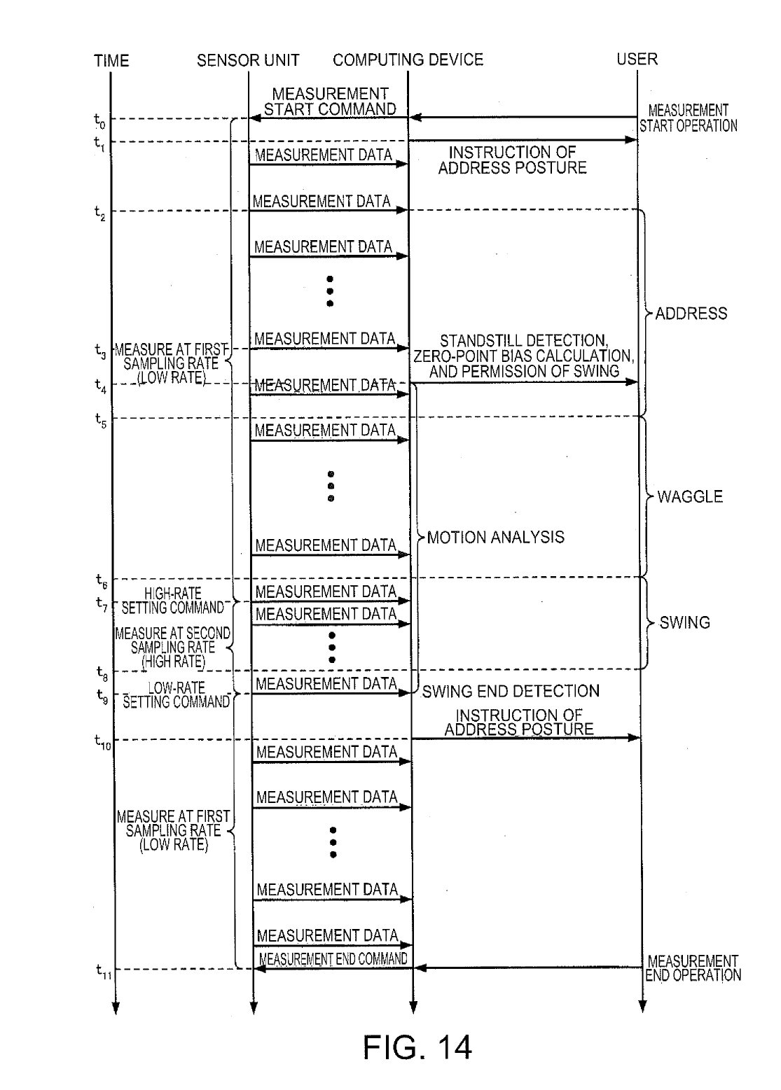

FIG. 14 is a diagram showing an example of a time chart of actions of the user 2, processing of the sensor unit 10, and processing of the computing device 20 in the third embodiment. In the example shown in FIG. 14, at time t0, the computing device 20 transmits a measurement start command to the sensor unit 10 according to the measurement start operation performed by the user 2. The sensor unit 10 receives the measurement start command, starts measurement at the first sampling rate (the low rate), and sequentially transmits measurement data to the computing device 20.

At time t1, the computing device 20 gives the user 2 notification for instructing the user 2 to take the address posture. The user 2 receives the notification and stands still in the address posture from time t2.

At time t3, the computing device 20 detects a predetermined standstill period and performs zero-point bias calculation using measurement data measured at the first sampling rate (the low rate) in the standstill period.

At time t4, the computing device 20 gives the user 2 notification for permitting the user 2 to perform swing. The user 2 receives the notification and, after performing waggle from time t5, performs the swing motion (the backswing, the downswing, and the follow-through) between time t6 and time t8.

At time t7, the sensor unit 10 detects a high-speed action of the user 2, switches the measurement to the measurement at the second sampling rate (the high rate), and sequentially transmits measurement data to the computing device 20.

The computing device 20 performs an analysis of the swing motion using the measurement data measured at the second sampling rate (the high rate) and, at time t9, detects an end of the swing motion.

At time t9, the sensor unit 10 detects a low-speed action of the user 2, switches the measurement to the measurement at the first sampling rate (the low rate), and sequentially transmits measurement data to the computing device 20.

At time t10, the computing device 20 gives the user 2 notification for instructing the user 2 to take the address posture.

After time t10, the user 2 may repeatedly perform a series of actions (address, waggle, and swing) same as the actions performed at time t2 to time t8. The sensor unit 10 and the computing device 20 repeatedly perform processing same as the processing at time t2 to time t10 according to the respective series of actions of the user 2.

Thereafter, at time t11, the computing device 20 transmits a measurement end command to the sensor unit 10 according to the measurement end operation performed by the user 2 and ends the processing. The sensor unit 10 receives the measurement end command and ends the measurement.

In the third embodiment, while the user 2 stands still in the address posture, the sensor unit 10 performs measurement at the first sampling rate, which is the low rate, and transmits measurement data to the computing device 20. Therefore, the computing device 20 can perform the detection of the standstill period substantially on a real-time basis. Therefore, it is possible to reduce time (time t2 to time t5 in FIG. 14) in which the user 2 stands still in the address posture and improve convenience for the user 2.

During the measurement at the first sampling rate, the sensor unit 10 detects a high-speed action at the start of the swing motion of the user 2, switches the measurement to the measurement at the second sampling rate, which is the higher rate, and transmits measurement data to the computing device 20. Therefore, during the swing motion excluding time immediately after the swing start of the user 2 (time t7 to time t9 in FIG. 14), the sensor unit 10 can transmit a large number of measurement data necessary for a motion analysis to the computing device 20. Therefore, the computing device 20 can acquire the large number of measurement data and accurately perform the motion analysis.

### Processing Procedure of the Computing Device

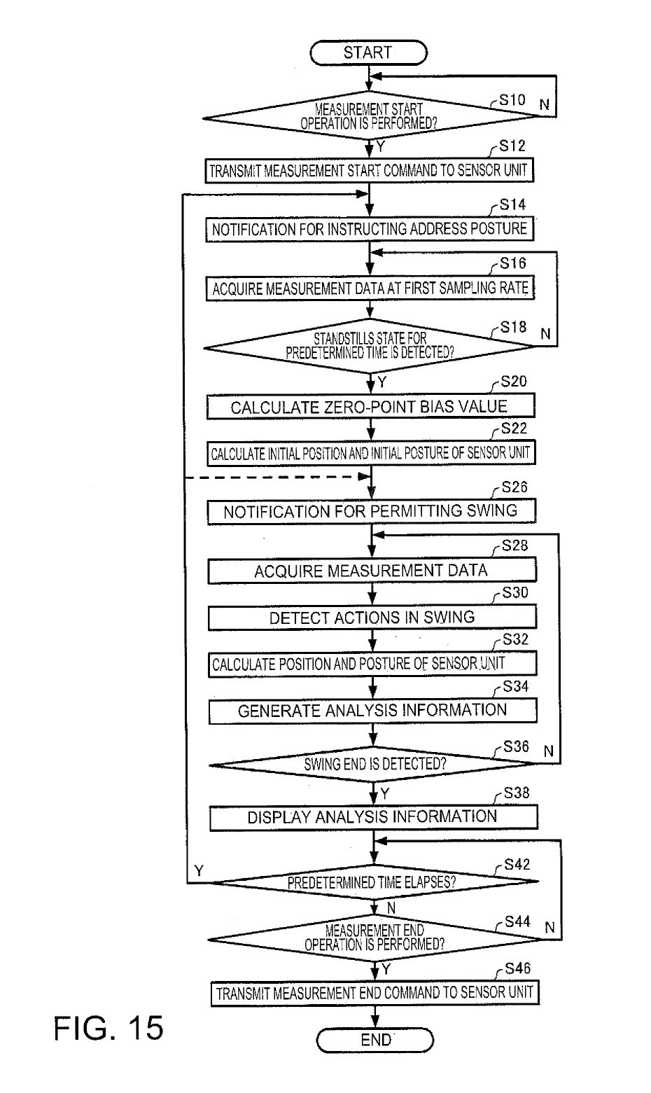

FIG. 15 is a flowchart for explaining a procedure of motion measurement processing by the processing section 21 of the computing device 20 in the third embodiment. In FIG. 15, steps of performing processing same as the processing in FIG. 7 are denoted by the same reference signs. The processing section 21 of the computing device 20 (an example of a computer) executes the motion measuring program 240 stored in the storing section 24 to thereby execute the motion measurement processing according to the procedure of the flowchart of FIG. 15. The flowchart of FIG. 15 is explained below centering on processing different from the processing in the flowchart of FIG. 7.

First, the processing section 21 stays on standby until the measurement start operation by the user 2 is performed (N in S10). When the measurement start operation is performed (Y in S10), as in the first embodiment (FIG. 7), the processing section 21 performs the processing in steps S12 to S22. Note that the processing section 21 does not perform the processing in step S24 in the first embodiment (FIG. 7).

Subsequently, as in the first embodiment (FIG. 7), the processing section 21 performs the processing in steps S26 to S38. However, in step S28, the processing section 21 acquires measurement data at the first sampling rate before the swing motion is started. Thereafter, the processing section 21 acquires measurement data at the second sampling rate. Note that the processing section 21 does not perform the processing in step S40 in the first embodiment (FIG. 7).

If the measurement end operation by the user 2 is not performed before a predetermined time elapses (Y in S42), the processing section 21 performs the processing in steps S14 to S38 again (or the processing section 21 may perform the processing in steps S26 to S38).

On the other hand, when the measurement end operation by the user 2 is performed before the predetermined time elapses (N in S42 and Y in S44), the processing section 21 transmits a measurement end command to the sensor unit 10 via the communication section 22 (S46) and ends the processing.

Note that, in the flowchart of FIG. 15, the order of the steps may be changed as appropriate if possible.

### Processing Procedure of the Sensor Unit

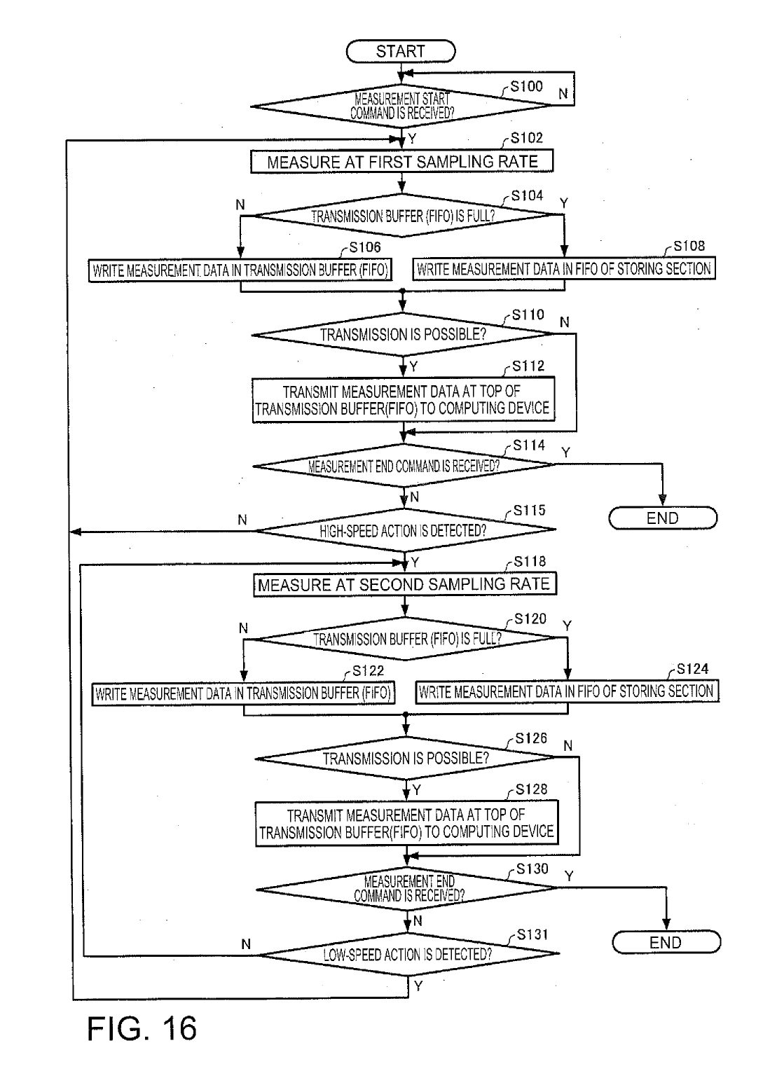

FIG. 16 is a flowchart for explaining a procedure of measurement processing of the sensor unit 10 in the third embodiment. In FIG. 16, steps for performing processing same as the processing in FIG. 8 are denoted by the same reference signs. The flowchart of FIG. 16 is explained below centering on processing different from the processing in the flowchart of FIG. 8.

First, the sensor unit 10 stays on standby until a measurement start command is received from the computing device 20 (N in S100). When receiving the measurement start command (Y in S100), the sensor unit 10 performs measurement (acquires three-axis acceleration data and three-axis angular velocity data) at the first sampling rate (S102).

Subsequently, as in the first embodiment (FIG. 8), the sensor unit 10 performs the processing in steps S104 to S112.

The sensor unit 10 repeats the processing in steps S102 to S112 until the sensor unit 10 receives a measurement end command from the computing device 20 or detects a high-speed action of the user 2 (N in S114 and N in S115).

When receiving the measurement end command (Y in S114), the sensor unit 10 ends the measurement processing.

When detecting the high-speed action of the user 2 (Y in S115), as in the first embodiment (FIG. 8), the sensor unit 10 performs the processing in steps S118 to S128.

The sensor unit 10 repeats the processing in steps S118 to S128 until the sensor unit 10 receives the measurement end command from the computing device 20 or detects a low-speed action of the user (N in S130 and N in S131).

When receiving the measurement end command (Y in S130), the sensor unit 10 ends the measurement processing.

When detecting the low-speed action of the user 2 (Y in S131), the sensor unit 10 performs the processing in step S102 and subsequent steps again.

Note that, in the flowchart of FIG. 16, the order of the steps may be changed as appropriate if possible.

### 1-3-4. Effects

According to the third embodiment explained above, effects same as the effects in the first embodiment can be attained. Further, since the sensor unit 10 automatically switches the sampling rate on the basis of measurement data, compared with the first embodiment, it is possible to reduce a processing load on the computing device 20.

### 2. Modifications

The invention is not limited to the embodiments. Various modified implementations of the invention are possible within the scope of the gist of the invention.

For example, in the embodiments, the sampling rate of the sensor unit 10 is set to any one of the two kinds of sampling rates: the first sampling rate (the low rate) and the second sampling rate (the high rate). However, the sampling rate may be set to any one of three or more kinds of sampling rates.

In the third embodiment, the sensor unit 10 determines the switching timing of the sampling rate on the basis of the amount of change of the measurement data. However, the sensor unit 10 may calculate the action speed of the user 2 on the basis of the measurement data and determine the switching timing on the basis of the action speed. The sensor unit 10 may change the sampling rate according to a range of the action speed of the user 2. For example, the sensor unit 10 may change the sampling rate to be higher as the action speed of the user 2 is higher.

In the third embodiment, when detecting the high-speed action of the user 2 on the basis of the measurement data, the sensor unit 10 may switch the sampling rate to the second sampling rate and switch the output mode to the buffering mode. When detecting the low-speed action of the user 2 on the basis of the measurement data, the sensor unit 10 may switch the sampling rate to the first sampling rate and switch the output mode to the real-time mode.

In the embodiments, the acceleration sensor 11 and the angular velocity sensor 12 are incorporated in the sensor unit 10 and integrated. However, the acceleration sensor 11 and the angular velocity sensor 12 do not have to be integrated. Alternatively, the acceleration sensor 11 and the angular velocity sensor 12 may be directly mounted on the golf club 3 or the user 2 without being incorporated in the sensor unit 10. In the embodiments, the sensor unit 10 and the computing device 20 are separate. However, the sensor unit 10 and the computing device 20 can be integrated and mounted on the golf club 3 or the user 2.

In the embodiments, the motion measuring system that measures the swing motion of the golf is explained as the example. However, the invention can be applied to motion measuring systems that measure various swing motions of tennis, baseball, and the like. The invention can also be applied to motion measuring systems that measure various motions other than the swing motions.

In the explanation in the embodiments, the swing motion of the user 2 is measured, that is, the user 2 is the measurement object. However, since it can also be considered that the motion of the golf club 3 is measured, the golf club 3 may be considered the measurement object. The invention can also be applied to any measurement object that can stand still and perform a motion, for example, exercise instruments other than the golf club 3 and objects other than the exercise instruments.

### 3. Motion Analyzing Apparatus

### 3-1. Fourth Embodiment

A golf swing analyzing apparatus (a motion analyzing apparatus), a motion analyzing method (a golf swing analyzing method) for analyzing a motion using the golf swing analyzing apparatus, and a motion analyzing program (a golf swing analyzing program) according to a fourth embodiment of the invention are explained. Note that the embodiment explained below does not unduly limit the contents of the invention described in the appended claims. Not all of components explained in this embodiment are essential as solving means of the invention.

### 3-1-1. Configuration of the Golf Club Analyzing Apparatus

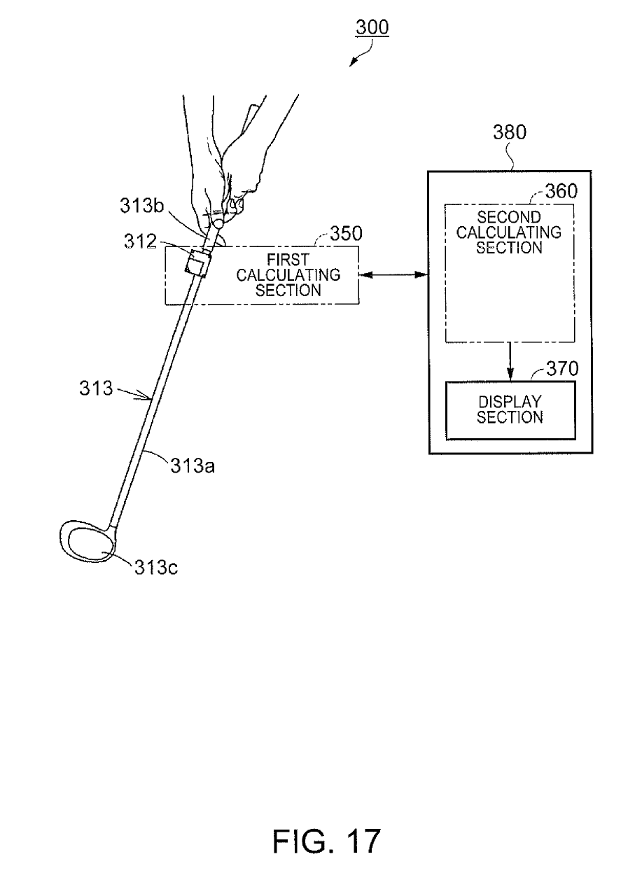

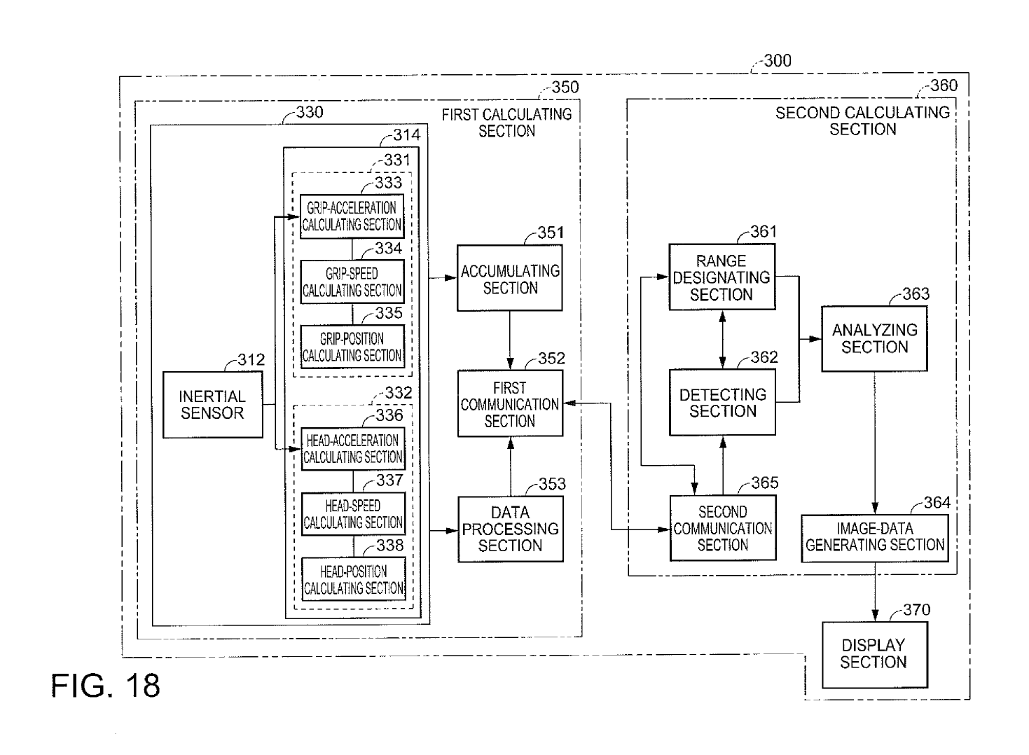

The configuration of the golf swing analyzing apparatus (the motion analyzing apparatus) according to the fourth embodiment of the invention is explained with reference to FIGS. 17 and 18. FIG. 17 is a conceptual diagram schematically showing the configuration of a golf swing analyzing apparatus (a motion analyzing apparatus) 300 according to the fourth embodiment of the invention. FIG. 18 is a block diagram schematically showing the configuration of the golf swing analyzing apparatus 300 according to the fourth embodiment of the invention.

The golf swing analyzing apparatus 300 includes a first calculating section 350 including, for example, an inertial sensor 312 and a second calculating section 360. Note that, in this embodiment, the first calculating section 350 is separated from the second calculating section 360 and connected by communication means (not shown in the figure). The second calculating section 360 in this embodiment is included in an information terminal apparatus 380 together with, for example, a display section 370. For example, an acceleration sensor and a gyro sensor are incorporated in the inertial sensor 312. The acceleration sensor can detect accelerations respectively in three axial directions orthogonal to one another. The gyro sensor can detect angular velocities respectively around three axes orthogonal to one another. The inertial sensor 312 outputs a detection signal. Acceleration and angular velocity are specified for each of the axes by the detection signal. The acceleration sensor and the gyro sensor accurately detect information concerning the acceleration and the angular velocity. The first calculating section 350 including the inertial sensor 312 is attached to a golf club (an exercise instrument) 313. The golf club 313 includes a shaft 313a and a grip 313b. The grip 313b is gripped by a hand of a subject (a user). The grip 313b is formed coaxially with the axis of the shaft 313a. A club head 313c is combined with the distal end of the shaft 313a. Desirably, the inertial sensor 312 is attached to the shaft 313a or the grip 313b of the golf club 313. The inertial sensor 312 only has to be fixed to the golf club 313 to be unable to relatively move. In attachment of the inertial sensor 312, one of detection axes of the inertial sensor 312 is adjusted to the axis of the shaft 313a.

### First Calculating Section

The first calculating section 350 includes a measuring section 330, an accumulating section 351 that accumulates first data measured by the measuring section 330, a first communication section 352 that performs transmission and reception of data, and a data processing section 353 that performs processing for thinning out the first data measured by the measuring section 330 and acquiring second data. Note that the first communication section 352 is equivalent to the transmitting section.

The measuring section 330 includes an inertial sensor 312. The inertial sensor 312 can perform detection (measurement) of swing. In the detection (the measurement) of the swing, for example, in order to accurately perform detection (measurement) of an action with high swing speed of the golf club 313 or the like, detection (measurement) at a relatively high sampling rate is requested. Therefore, the inertial sensor 312 performs the detection (the measurement) of the swing at a sampling rate of, for example, 1000 SPS (Samples per Second; hereinafter referred to as “SPS”), which is the relatively high first sampling rate, and acquires the detected swing as the first data.

The inertial sensor 312 is connected to a first detecting section 331 and a second detecting section 332 via a not-shown interface circuit. The first detecting section 331 and the second detecting section 332 configure an arithmetic processing circuit 314. A detection signal (the first data) is supplied from the inertial sensor 312 to the first detecting section 331 and the second detecting section 332 functioning as the arithmetic processing circuit 314.

The first detecting section 331 can detect an inertia amount of the grip 313b during a motion on the basis of an output of the inertial sensor 312. Similarly, the second detecting section 332 can detect an inertia amount of the club head 313c during the motion on the basis of the output of the inertial sensor 312.

The first detecting section 331 includes a grip-acceleration calculating section 333, a grip-speed calculating section 334, and a grip-position calculating section 335. The grip-acceleration calculating section 333 is connected to the inertial sensor 312. The grip-acceleration calculating section 333 can calculate the acceleration of the grip 313b on the basis of an output of the inertial sensor 312. In the calculation of the acceleration, the grip-acceleration calculating section 333 specifies the position of the grip 313b according to a local coordinate system peculiar to the inertial sensor 312.

The grip-speed calculating section 334 is connected to the grip-acceleration calculating section 333. The grip-speed calculating section 334 can calculate the moving speed of the grip 313b on the basis of an output of the grip-acceleration calculating section 333. In the calculation, the grip-speed calculating section 334 applies, at a specified sampling interval, integration processing to the acceleration calculated by the grip-acceleration calculating section 333. The grip-speed calculating section 334 can calculate the moving speed of the grip 313b.

The grip-position calculating section 335 is connected to the grip-speed calculating section 334. The grip-position calculating section 335 can calculate the position of the grip 313b on the basis of an output of the grip-speed calculating section 334. In the calculation, the grip-position calculating section 335 applies, at the specified sampling interval, integration processing to the speed calculated by the grip-speed calculating section 334.

The second detecting section 332 includes a head-acceleration calculating section 336, a head-speed calculating section 337, and a head-position calculating section 338. The head-acceleration calculating section 336 is connected to the inertial sensor 312. The head-acceleration calculating section 336 can calculate the acceleration of the club head 313c on the basis of an output of the inertial sensor 312. In the calculation of the acceleration, the head-acceleration calculating section 336 specifies the position of the club head 313c according to the local coordinate system peculiar to the inertial sensor 312.

The head-speed calculating section 337 is connected to the head-acceleration calculating section 336. The head-speed calculating section 337 can calculate the moving speed of the club head 313c on the basis of an output of the head-acceleration calculating section 336. In the calculation, the head-speed calculating section 337 applies, at the specified sampling interval, integration processing to the acceleration calculated by the head-acceleration calculating section 336.

The head-position calculating section 338 is connected to the head-speed calculating section 337. The head-position calculating section 338 can calculate the position of the club head 313c on the basis of an output of the head-speed calculating section 337. In the calculation, the head-position calculating section 338 applies, at the specified sampling interval, integration processing to the speed calculated by the head-speed calculating section 337.

An accumulating section (a storage device) 351 is connected to the arithmetic processing circuit 314. In the accumulating section 351, for example, a golf swing analysis software program (a motion analyzing program) and data related thereto (including the first data measured by the measuring section 330) can be stored. The arithmetic processing circuit 314 executes the golf swing analysis software program and executes an analysis of golf swing. The accumulating section (the storage device) 351 can include a DRAM (dynamic random access memory), a large-capacity storage device unit, and a nonvolatile memory. For example, in the DRAM, the golf swing analysis software program is temporarily stored in implementation of a golf swing analyzing method. The golf swing analysis software program and the data are stored in the large-capacity storage device unit such as a hard disk driving device (HDD). A relatively small-capacity program such as a BIOS (basic input/output system) and data are stored in the nonvolatile memory.

The data processing section 353 is connected to the arithmetic processing circuit 314. The data processing section 353 can perform processing for thinning out the first data measured at the first sampling rate of, for example, 1000 SPS to the second sampling rate of, for example, 250 SPS lower than the first sampling rate to obtain the second data. In the processing for thinning out the first data to the second sampling rate, for example, first data in sampling interval of the second sampling rate can be regarded as a representative value and set as the second data or the first data in the sampling interval (time) of the second sampling rate can be averaged and an average of the first data can be set as the second data. With such a method, the processing for thinning out the first data to the second data can be performed by a simple method.

The accumulating section (the storage device) 351 and the data processing section 353 are connected to the first communication section 352. The first communication section 352 has a function of a transmitting section that transmits the measurement data including the first data and the second data to the second calculating section 360 and a function of a receiving section that receives a data request from the second calculating section 360. The first communication section 352 can transmit the second data obtained by thinning out the first data to the second sampling rate to the second calculating section 360 on a real-time basis. The first communication section 352 can receive a request for data transmission, a time range of which in swing is designated, from the second calculating section 360, acquire third data corresponding to the request out of the first data accumulated in the accumulating section 351, and transmit the third data to the second calculating section 360.

### Second Calculating Section

The second calculating section 360 includes a range designating section 361 that designates a time range in swing and requests the third data from the first calculating section 350, a detecting section 362 that detects an event of the swing from the second data, an analyzing section 363 that analyzes the swing using the first data and the third data, an image-data generating section 364 that converts an analysis result into image data, and a second communication section 365 that performs communication with the first calculating section 350. Note that the second calculating section 360 includes a display section 370 that is connected to the image-data generating section 364 and displays an analysis result. The display section 370 may have, in addition to a display function, an input function for performing a data input and an instruction input. The second calculating section 360 may be replaced with, for example, a smart phone, a cellular phone terminal, or a tablet PC (personal computer).

The second communication section 365 can perform communication with the first communication section 352 of the first calculating section 350 and perform transmission and reception of data. The second communication section 365 has a function of receiving the measurement data (the second data and the third data) in the first calculating section 350 and a function of receiving, from the range designating section 361, a time range in which a detailed swing analysis is necessary and requesting the third data to the first calculating section 350.

The detecting section 362 and the range designating section 361 are connected to the second communication section 365. The detecting section 362 can detect an event of the swing from the second data. The event of the swing can be rephrased as “timing of respective actions and states in the swing”. Examples of the event include a stop during address, a backswing start, a downswing start, impact, and a swing end and a state of head speed during the swing. As an example of the event of the swing, detection of a standstill state of the swing, timing of the impact, timing of the top, and timing of an end (finish) of the swing is explained.

The detecting section 362 can detect, as one of events of the swing, a standstill state of the swing on the basis of the second data. The detection of the standstill state of the swing is explained. The second data is used as output data from the inertial sensor 312 that detects the standstill state. In the standstill state of the swing, angular velocity measured by the inertial sensor 312 is zero. However, acquired angular velocity data is not zero and includes a bias value that changes with time. The bias value is measured in advance in the standstill state of the swing. It is possible to detect the standstill state of the swing by subjecting the bias value to subtraction processing.

The detecting section 362 can detect, as one of the events of the swing, timing of the impact of the swing on the basis of the second data. The detecting section 362 subjects the first data measured by the measuring section 330 to processing for calculating a combined value such as a sum or a product of magnitudes of inertia amounts around a plurality of axes on the basis of the second data subjected to the thinning-out processing in the data processing section 353. The detecting section 362 performs processing for, for example, differentiating, with time, the combined value of the inertia amounts calculated in this way. For example, an example is explained in which a combined value, that is, a sum of magnitudes of angular velocities of axes of a three-axis angular velocity sensor is used. The detecting section 362 detects the timing of the impact as timing when the combined value of the angular velocities is the maximum, in other words, timing of a maximum of the angular velocity of the swing. Alternatively, the detecting section 362 detects, as the timing of the impact, earlier timing of timing when a value of differentiation of a norm of the angular velocity is the maximum and timing when the value is the minimum.

As one of the events of the swing, the detecting section 362 can detect timing of the top of the swing on the basis of the second data. The detecting section 362 detects, as the timing of the top of the swing, timing that is earlier than the detected timing of the impact and when the combined value of the angular velocities is the minimum.

The detecting section 362 detects, as timing of the end (finish) of the swing, timing that is later than the impact and when the combined value of the angular velocities is the minimum.

The range designating section 361 connected to the second communication section 365 can designate, on the basis of the event of the swing detected by the detecting section 362, a time range in which a detailed swing analysis is necessary in the swing performed by the subject and request data in the time range to the first calculating section 350 as the third data. That is, the third data is data in the time range designated by the range designating section 361 acquired out of the first data measured at the first sampling rate and accumulated in the accumulating section 351 of the first calculating section 350. Therefore, an analysis evaluation of the swing can be performed using the data (the third data) measured at the relatively high first sampling rate. Note that the request for the third data is performed via the second communication section 365 of the second calculating section 360 and the first communication section 352 of the first calculating section 350.

The subject can set the time range in advance. As the time range, for example, with a maximum point of swing speed set as the event of the swing, a predetermined time range is automatically set before and after the maximum point. Note that, for the setting of the maximum, other inertia amounts such as a rotation angle and acceleration may be used other than the swing speed. By setting the time range in which the analysis is necessary in this way, even if the subject does not perform a manual input every time, the range designation is automatically performed and the analysis evaluation can be performed. Therefore, it is possible to improve convenience of use.

As the time range in which the second data is requested, a plurality of ranges can be set. By setting the plurality of time ranges in this way, a plurality of analysis evaluation ranges (analysis evaluation places), which the subject desires to know in detail, can be optionally set. Therefore, it is possible to obtain a more detailed analysis evaluation result. It is possible to improve convenience of use.

The range designating section 361 and the detecting section 362 are connected to the analyzing section 363. The analyzing section 363 can analyze the swing using the first data and the third data. The analyzing section 363 combines the first data measured at the relatively high first sampling rate and the third data obtained by thinning out the first data to the relatively low second sampling rate and outputs combined data to the image-data generating section 364 as time-series analysis data. The analyzing section 363 combines the third data in the designated time range, which is a detailed analysis portion, and the first data in time other than the time range of the third data and calculates combined data as, for example, graph data or swing locus data.

The analyzing section 363 is connected to the image-data generating section 364. The image-data generating section 364 can generate image data on the basis of the analysis data such as the graph data or the swing locus data output from the analyzing section 363. The display section 370 is connected to the image-data generating section 364. In the connection, a predetermined interface circuit (not shown in the figure) is connected to the image-data generating section 364. The image-data generating section 364 sends an image signal to the display section 370 according to the input analysis data. An image specified by the image signal is rendered on a screen of the display section 370. As the display section 370, for example, a flat panel display such as a liquid crystal display is used. The range designating section 361, the detecting section 362, the analyzing section 363, and the image-data generating section 364 are provided as, for example, a computer apparatus.

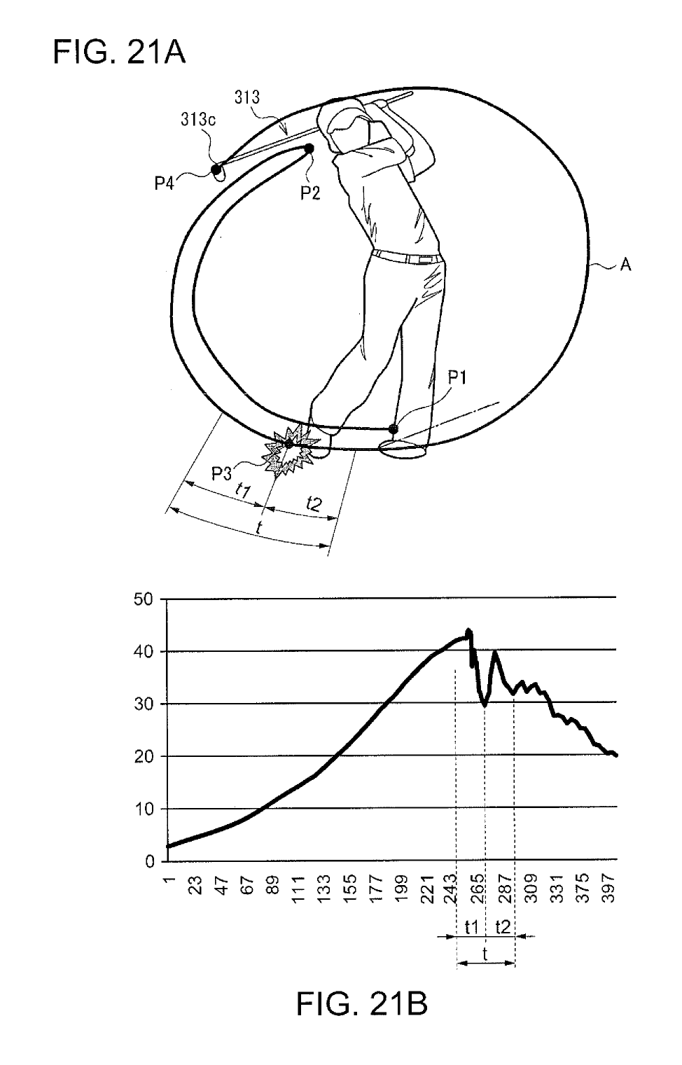

The display section 370 can render an image shown in FIGS. 21A and 21B on the basis of the image data output from the image-data generating section 364. FIGS. 21A and 21B are conceptual diagrams showing a display example of a golf swing analysis in a motion analysis display method according to the fourth embodiment. FIG. 21A is a conceptual diagram showing a swing locus. FIG. 21B is an example of a graph showing an analysis result of swing in time series.

The display section 370 displays the rendered image of the swing locus shown in FIG. 21A and the graph showing the analysis result of the swing in time series shown in FIG. 21B. In FIG. 21A, the locus of the swing is displayed. For example, on a locus A of the swing, standstill timing P1 indicating a standstill state, top timing P2 indicating the top, impact timing P3 indicating the impact, finish timing P4 indicating the end (finish) of the swing, and the like are rendered. In the graph shown in FIG. 21B, a range time t in which a predetermined time t1 is set before the impact timing P3 and a predetermined time t2 is set after the impact timing P3 with reference to the impact timing P3 is combined using the first data and using the second data. It is possible to analyze a behavior of the graph and evaluate the quality of the swing.

By rendering the timings on the display section 370 in this way, the second data thinned out to the relatively low second sampling rate and the third data acquired by designating the time range out of the first data measured at the relatively high first sampling rate can be displayed (rendered) as a series of data one on top of another as an analysis result of the swing. Consequently, it is possible to easily visually recognize the different data of the sampling rate as one image.

Note that, in the golf swing analyzing apparatus 300 in this embodiment, the first calculating section 350 and the second calculating section 360 are respectively separately configured. Transmission and reception of data is performed by a communication line. However, the golf swing analyzing apparatus 300 is not limited to this configuration. The golf swing analyzing apparatus 300 may have a so-called integrated configuration in which, for example, the first calculating section 350 and the second calculating section 360 are housed in one package. With such an integrated structure, for example, processing on the second calculating section 360 side can be performed on the first calculating section 350 side. It is possible to reduce a calculation load on the second calculating section 360. Since the first calculating section 350 and the second calculating section 360 are integrated, it is possible to simplify a data transmitting and receiving function and the like. It is possible to attain a reduction in the size of the golf swing analyzing apparatus 300. In the golf swing analyzing apparatus 300 in this embodiment, the arithmetic processing circuit 314 is disposed in the first calculating section 350 (the measuring section 330). However, the arithmetic processing circuit 314 may be disposed in the second calculating section 360 (e.g., the analyzing section 363).

With the golf swing analyzing apparatus 300 having the configuration explained above, the first calculating section 350 accumulates, in the accumulating section 351, the first data measured at the relatively high first sampling rate and transmits the second data obtained by thinning out the first data to the second sampling rate lower than the first sampling rate in the data processing section 353 to the second calculating section 360. The second calculating section 360 detects the event of the swing on the basis of the second data. The range designating section 361 designates, on the basis of the detected event, the time range in which a detailed analysis is necessary and acquires the third data, which is the data in the designated time range, out of the first data accumulated in the accumulating section 351. In this way, the analysis of the swing is performed using, in the time range in which a detailed analysis evaluation is necessary, the third data measured at the relatively high first sampling rate and using, in the other ranges, the second data thinned out at the relatively low second sampling rate. Therefore, compared with the method in the past for analyzing the entire swing on the basis of the data measured at the relatively high sampling rate, it is possible to reduce a data amount in this embodiment. It is possible to reduce a data processing time including a communication time of data. As a result, it is possible to reduce or prevent a so-called time lag from the swing to presentation of an analysis evaluation result. It is possible to reduce an analysis evaluation time for the swing. Consequently, the user is less frequently kept waited until the start of the next swing after the swing analyzing. It is possible to improve convenience of use. Since the data amount can be reduced, a communication amount decreases and a consumed current can be reduced. It is possible to provide the golf swing analyzing apparatus 300 with low power consumption.

### 3-1-2. Golf Swing Analyzing Method

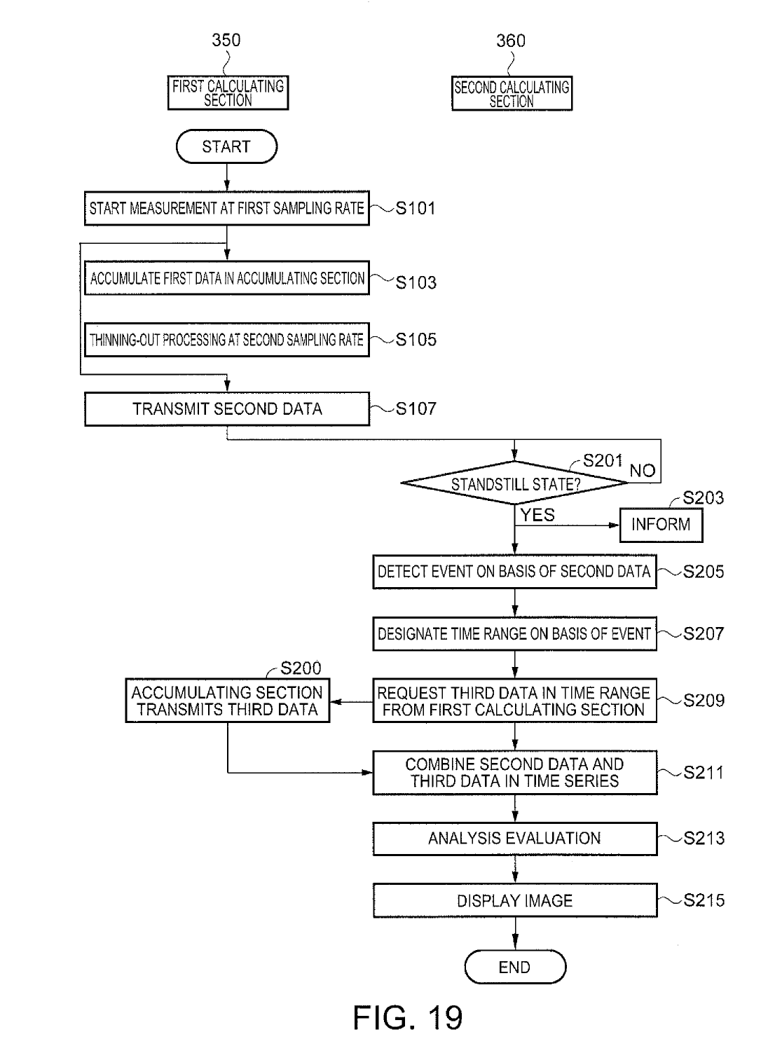

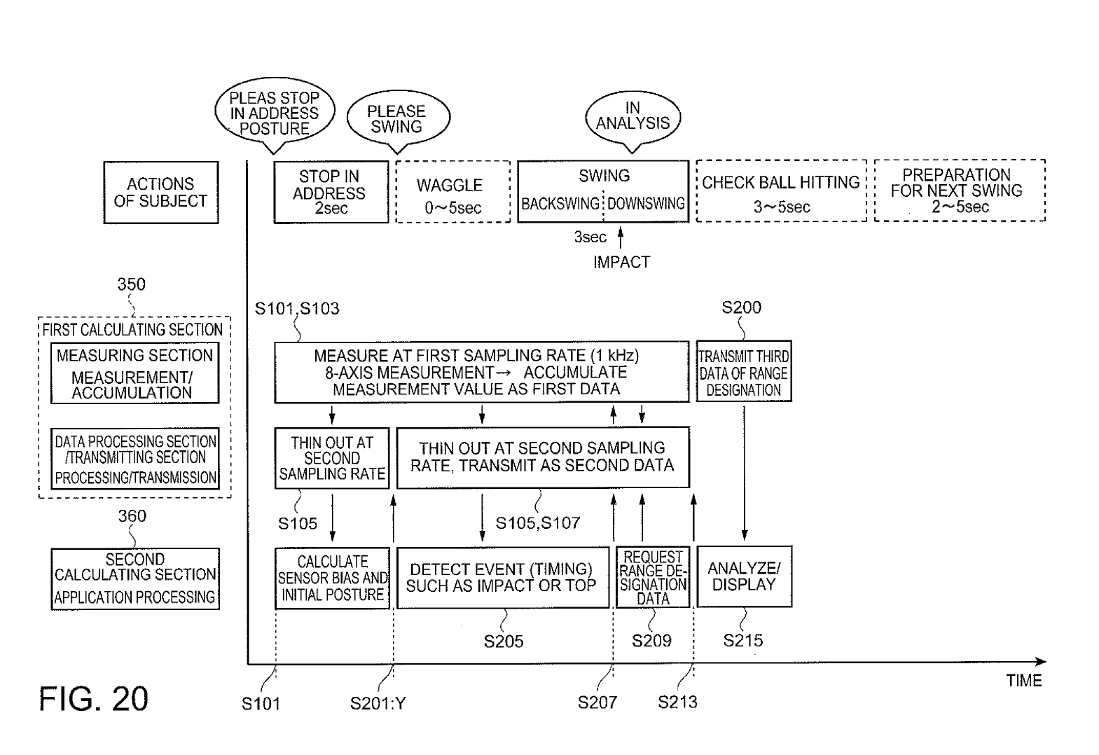

A motion analyzing method (a golf swing analyzing method) for analyzing a motion using the golf swing analyzing apparatus 300 and a motion analyzing program (a golf swing analyzing program) are explained with reference to FIGS. 19 and 20. FIG. 19 is a flowchart for explaining a golf swing analyzing method (a motion analyzing method) according to the fourth embodiment of the invention. FIG. 20 is a conceptual diagram showing the golf swing analyzing method (the motion analyzing method) according to the fourth embodiment. Note that configurations of the golf swing analyzing apparatus 300 are explained using reference numerals same as the reference numerals described above.

Before explaining the golf swing analyzing method, actions of general golf swing of a subject are explained with reference to FIG. 20. First, the subject grips a golf club and takes a posture for hitting a ball, so-called address. In the address, the golf club is once stopped. Subsequently, the subject relaxes, slightly bends the wrists back and forth, and moves a club head slightly to the left and right while alternately putting the weight of the subject on the right foot and the left food a few times after the address. That is, the subject shifts to so-called waggle. After the waggle, the subject starts backswing and shifts from the top to downswing and to impact, which is an instance when the club head hits the ball. Thereafter, for example, the subject checks the hit ball while shifting from follow-through to finish.

The golf swing analyzing method in this embodiment is explained below. First, in the first calculating section 350, the inertial sensor 312 configuring the measuring section 330 starts detection (measurement) of swing (step S101). Step S101 starts before the swing is started. In order to improve detection accuracy, the detection (the measurement) of the swing is performed at the relatively high first sampling rate, for example, 1000 SPS.

Subsequently, the accumulating section 351 configuring the first calculating section 350 accumulates the first data acquired at the sampling rate of 1000 SPS (step S103). In addition, the data processing section 353 performs processing for thinning out the first data to the second sampling rate lower than the first sampling rate, for example, 250 SPS to obtain the second data (step S105). In the processing for thinning out the first data to the second sampling rate, for example, first data corresponding to the second sampling rate can be regarded as a representative value and set as the second data or the first data in a second sampling rate region (time) can be averaged and an average of the first data can be set as the second data. The first communication section 352 transmits the second data thinned out to 250 SPS to the second calculating section 360 (the second communication section 365) on a real-time basis (step S107).

Subsequently, the detecting section 362 configuring the second calculating section 360 receives the second data thinned out to 250 SPS. The detecting section 362 determines from the second data whether the swing is in a standstill state as one of events of the swing (step S201). In the determination, the detecting section 362 calculates a bias value for correcting a measurement error of the inertial sensor 312. In the standstill state of the swing, an angular velocity measured by the inertial sensor 312 is zero. However, acquired angular velocity data is not zero and includes a bias value that changes with time. The bias value is measured in advance in the standstill state of the swing. The detecting section 362 detects the standstill state of the swing by subjecting the bias value to subtraction processing. The detecting section 362 determines, using the bias value, whether the swing is in the standstill state (an initial posture). If the swing is in the standstill state (the initial posture) (YES in step S201), the detecting section 362 informs the subject (step S203) and shifts to a step of detecting an event (step S205). If the swing is not in the standstill state (NO in step S201), the detecting section 362 repeats the determination and waits until the swing changes to the standstill state. Note that, by informing the subject that the swing is in the standstill state (the initial posture) (YES in step S201), the information can be used as a sign for starting the swing. It is possible to improve accuracy of an analysis evaluation result and convenience of use.

Subsequently, the detecting section 362 of the second calculating section 360 detects, as an example of events of the swing, timing of the impact of the swing on the basis of the second data (step S205). The detecting section 362 performs processing for calculating a combined value such as a sum or a product of magnitudes of angular velocities around a plurality of axes on the basis of the second data obtained by thinning out, in the data processing section 353, the first data measured by the measuring section 330. The detecting section 362 performs processing for differentiating the combined value of the angular velocities with time. The timing of the impact can be detected using the combined value of the angular velocities. The timing of the impact is detected as timing when the combined value of the angular velocities is the maximum. Alternatively, earlier timing of timing when a value of the differentiation of the combined value of the angular velocities is the maximum and timing when the value is the minimum can be detected as the timing of the impact.

Subsequently, the range designating section 361 designates, on the basis of the timing of the impact of the swing detected by the detecting section 362 in step S205, a time range in which a detailed swing analysis is necessary (step S207). In this example, the time range is set before and after the timing of the impact of the swing. Note that the subject can set the time range in step S207 in advance.

Subsequently, the range designating section 361 requests data in the designated time range to the first calculating section 350 (the accumulating section 351) as the third data via the second communication section 365 and the first communication section 352 (step S209). The accumulating section 351 of the first calculating section 350 transmits the third data in the time range requested by the range designating section 361 to the range designating section 361 via the first communication section 352 and the second communication section 365 (step S200). Note that the third data is data in the time range designated by the range designating section 361 acquired out of the first data measured at the first sampling rate and accumulated in the accumulating section 351 of the first calculating section 350. Therefore, an analysis evaluation of the swing can be performed using the data (the third data) measured at the relatively high first sampling rate.

Subsequently, the analyzing section 363 analyzes the swing using the second data and the third data. The analyzing section 363 combines, as time-series evaluation data, the third data, which is the data in the designated time range in the first data measured at the relatively high sampling rate, and the second data obtained by thinning out the first data to the relatively low sampling rate (step S211). The analyzing section 363 performs an analysis and an evaluation according to the evaluation data (step S213) and outputs the evaluation data to the image-data generating section 364 as analysis data such as graph data or swing locus data.

Subsequently, the image-data generating section 364 generates image data on the basis of the analysis data such as the graph data or the swing locus data output from the analyzing section 363 and transmits the image data to the display section 370 as an image signal. The display section 370 renders an image specified by the transmitted image signal (step S215). The subject evaluates the golf swing of the subject according to the image rendered on the display section 370 to thereby end the analysis and shifts to the next swing. Note that, in the range designating section 361, the detecting section 362, the analyzing section 363, the image-data generating section 364, and the like, for example, a computer apparatus can be used. The golf swing analyzing method is programmed as an operation program of the computer apparatus.

With the golf swing analyzing method explained above, the analysis of the swing is performed using, in the time range in which a detailed analysis evaluation is necessary, the third data measured at the relatively high first sampling rate and using, in the other ranges, the second data thinned out at the relatively low second sampling rate, which is a rate lower than the first sampling rate. Therefore, compared with the method in the past for analyzing the entire swing on the basis of the data measured at the relatively high sampling rate, it is possible to reduce a data amount in this embodiment. It is possible to reduce a data processing time including a communication time of data. As a result, it is possible to reduce or prevent a so-called time lag from the swing to presentation of an analysis evaluation result. It is possible to reduce an analysis evaluation time for the swing. Consequently, the user is enabled to be less frequently kept waited or not to be kept waited at all until the start of the next motion after the swing analyzing. It is possible to improve convenience of use.

The golf swing analyzing method can be implemented by executing a motion analyzing program programmed in a computer apparatus provided in a component. It is possible to perform efficient and quick processing by using such a motion analyzing program.

Note that, in the fourth embodiment, the golf swing analyzing apparatus and the golf swing analyzing method for performing an analysis of golf swing are explained as the examples. However, those skilled in the art can easily understand that a large number of modifications not substantially departing from the new matters and the effects of the invention are possible. Therefore, all of such modifications are deemed to be included in the scope of the invention. For example, the measurement object in the invention can be suitably applied to various exercise instruments used for swing such as a golf club, rackets of tennis and badminton, bats of baseball and softball, and a racket of table tennis. The motion analyzing apparatus according to the invention can also be used for, for example, an analysis of jump and rotation postures of gymnastics, an analysis of techniques such as step, spin, and jump of figure skating, an analysis of taking-off timing and a taking-off direction of jump in skiing, and a motion analysis of a robot.

The first to fourth embodiments and the modifications explained above are examples. The invention is not limited thereto. For example, the embodiments and the modifications can be combined as appropriate.

Note that the invention includes configurations substantially the same as the configurations in the embodiments (e.g., configurations having the same functions, methods, and results or configurations having the same purposes and effects). The invention includes configurations in which non-essential portions of the configurations explained in the embodiments are replaced. The invention includes configurations that realize action and effects same as the action and effects of the configurations explained in the embodiments and configurations that can attain objects same as the objects of the embodiments. The invention includes configurations in which publicly-known techniques are added to the configurations explained in the embodiments.

The entire disclosure of Japanese Patent Application No. 2014-079188, filed Apr. 8, 2014 and No. 2014-197266, filed Sep. 26, 2014 are expressly incorporated by reference herein.

What is claimed is:

1. A sensor comprising:
a measuring section; and
a sampling-rate switching section configured to switch a sampling rate at which the measuring section performs measurement, wherein
the measuring section performs the measurement at a first sampling rate in a standstill period of a measurement object and, in a motion period of the measurement object, switches the sampling rate to a second sampling rate with the sampling-rate switching section, and performs the measurement, and
the first sampling rate is lower than the second sampling rate.

2. The sensor according to claim 1, wherein the sampling-rate switching section switches the first sampling rate to the second sampling rate on the basis of a first switching signal from an outside.

3. A computing device comprising:
a standstill-period detecting section configured to detect, on the basis of first measurement data measured by a sensor at a first sampling rate, a standstill period in which a measurement object stands still; and
a sensor control section configured to transmit, when the standstill-period detecting section detects the standstill period, to the sensor, a first switching signal for instructing switching to a second sampling rate, wherein
the first sampling rate is lower than the second sampling rate.

4. The computing device according to claim 3, wherein the standstill-period detecting section detects the standstill period when the first measurement data is within a predetermined range in a predetermined time.

5. The computing device according to claim 3, further comprising a zero-point-bias calculating section configured to calculate a zero-point bias value of the first measurement data of the sensor when the standstill-period detecting section detects the standstill period.

6. The computing device according to claim 5, wherein the zero-point-bias calculating section calculates an average of the first measurement data in the standstill period and sets the average as the zero-point bias value.

7. The computing device according to claim 3, further comprising a motion analyzing section configured to analyze a motion of the measurement object using second measurement data measured by the sensor at the second sampling rate.

8. The computing device according to claim 3, further comprising a motion-end detecting section configured to detect an end of a motion of the measurement object, wherein
when the motion-end detecting section detects the end of the motion of the measurement object, the sensor control section transmits, to the sensor, a second switching signal for instructing switching to the first sampling rate.

9. The computing device according to claim 3, wherein the first sampling rate is equal to or lower than an output rate at which the sensor outputs the first measurement data.

10. A motion analyzing apparatus comprising:
a measuring section configured to measure a motion as first data at a first sampling rate;
a data processing section configured to process the first data into a second sampling rate lower than the first sampling rate to obtain second data;
a detecting section configured to detect an event of the motion from the second data;
a range designating section configured to designate a time range in the motion on the basis of the detected event and receive the first data in the time range as third data; and
an analyzing section configured to analyze the motion using the second data and the third data.

11. The motion analyzing apparatus according to claim 10, wherein the detecting section detects a standstill state of the motion as the event.

12. The motion analyzing apparatus according to claim 10, wherein the data processing section performs processing for calculating an average of the first data within a sampling interval of the second sampling rate.

13. The motion analyzing apparatus according to claim 10, wherein the time range is set to a range before and after a point in time of a maximum of an inertial amount in the motion.

14. The motion analyzing apparatus according to claim 10, wherein a plurality of the time ranges are set.

15. The motion analyzing apparatus according to claim 10, wherein
the measuring section and the data processing section are provided in a first calculating section, and
the detecting section, the range designating section, and the analyzing section are provided in a second calculating section.

16. The motion analyzing apparatus according to claim 10, wherein the motion is swing performed using an exercise instrument.
